(19) United States
(12) Patent Application Publication
(10) Pub. No.: US 2023/0306437 A1
(43) Pub. Date: Sep. 28, 2023

(54) MERCHANDISE REGISTRATION DEVICE, METHOD FOR MERCHANDISE REGISTRATION DEVICE, AND MERCHANDISE REGISTRATION SYSTEM

(71) Applicant: Toshiba Tec Kabushiki Kaisha, Tokyo (JP)

(72) Inventors: Kenya HIRAMATSU, Kita Tokyo (JP); Tsuyoshi GOTANDA, Ota Tokyo (JP)

(21) Appl. No.: 18/175,383

(22) Filed: Feb. 27, 2023

(30) Foreign Application Priority Data
Mar. 28, 2022 (JP) 2022-052183

(51) Int. Cl. G06Q 30/016; G06Q 20/20

(52) U.S. Cl. CPC G06Q 30/016; G06Q 20/208; G06Q 20/209; G06Q 20/202

(57) ABSTRACT

According to one embodiment, a merchandise registration device includes a processor. The processor is configured to register merchandise to be purchased by a customer in a sales transaction and receive a designation of services to be applied to the registered merchandise after settlement of the sales transaction. The processor stores the designation of services in association with the registered merchandise and outputs a list of the registered merchandise associated with the designated services to be applied after settlement of the sale transaction. In some examples, the list may be output as a printed receipt, a service request receipt, or the like to be presented at a service counter or the like to permit more efficient service request handling.

### CROSS-REFERENCE TO RELATED APPLICATION

This application is based upon and claims the benefit of priority from Japanese Patent Application No. 2022-052183, filed Mar. 28, 2022, the entire contents of which are incorporated herein by reference.

### FIELD

Embodiments described herein relate generally to a merchandise registration device, a method for a merchandise registration device, and a merchandise registration system.

### BACKGROUND

A service counter may be provided in a large store such as a supermarket or a department store. The service counter handles requests and processing related to services available to customers, such as a delivery service for delivering the merchandise purchased by customers to their homes, a packaging service for packaging the merchandise, and the like.

Typically, a customer using a service counter brings merchandise for which settlement has already been completed to the service counter and then verbally informs a store clerk of the service being requested along with the merchandise for which the service is requested. The store clerk performs processing related to the service requested by the customer and keeps a record of the type of service and the merchandise by, for example, listing the service and the merchandise in a ledger or inputting the information into a dedicated terminal. Also, if the requested service requires a fee, the store clerk will charge the customer for the fee and receive payment.

In this way, since various exchanges occur between the store clerk and the customers regarding services provided after settlement, it takes some amount of time to respond to each of the customers requesting a post-settlement service, and there is a demand for increased efficiency in such operations.

### BRIEF DESCRIPTION OF THE DRAWINGS

FIG. 1 is a block diagram showing a schematic configuration of a merchandise registration system according to a first embodiment.

FIG. 2 is a schematic diagram of a merchandise record.

FIG. 3 is a schematic diagram of a member record.

FIG. 4 is a schematic diagram of a service record.

FIG. 5 is a schematic diagram showing an example of a service record relating to a delivery service.

FIG. 6 is a schematic diagram showing an example of a service record relating to a packaging service.

FIG. 7 is a block diagram of an information terminal.

FIG. 8 is a block diagram of a settlement terminal.

FIG. 9 is a block diagram showing of a mobile controller.

FIG. 10 is a schematic diagram showing data items stored in a transaction file.

FIG. 11 is a schematic diagram for illustrating functions of a processor of a mobile controller.

FIGS. 12-15 are flowcharts of processing executed by a processor of an information terminal.

FIGS. 16-24 are flowcharts of processing executed by a processor of a mobile controller.

FIG. 25 is a flowchart of processing executed by a processor of a settlement terminal according to a program.

FIG. 26 is a schematic diagram of a start screen displayed on a touch panel of an information terminal.

FIG. 27 is a schematic diagram of a registration screen displayed on a touch panel of an information terminal.

FIG. 28 is a schematic diagram of a service screen displayed on a touch panel of an information terminal.

FIG. 29 is a schematic diagram of a service screen after a packaging service request.

FIG. 30 is a schematic diagram of a service screen after receiving a denial response command.

FIG. 31 is a schematic diagram of a delivery destination designation screen displayed on a touch panel of an information terminal.

FIG. 32 is a schematic diagram of receipts dispensed from a settlement terminal.

FIG. 33 is a block diagram showing a schematic configuration of a merchandise registration system according to a second embodiment.

FIG. 34 is a block diagram of a self-service POS terminal.

FIGS. 35-38 are flowcharts of processing executed by a processor of a self-service POS terminal.

FIG. 39 is a schematic diagram of a registration screen.

FIG. 40 is a schematic diagram of a service screen.

FIG. 41 is a schematic diagram of a target merchandise list screen.

FIG. 42 is a schematic diagram of a delivery destination designation screen.

FIG. 43 is a schematic diagram of another target merchandise list screen.

### DETAILED DESCRIPTION

Exemplary embodiments described herein provide a merchandise registration device, a method for the same, and a merchandise registration system that can improve the efficiency of operations related to services performed after merchandise settlement.

In general, according to one embodiment, a merchandise registration device includes a processor. The processor is configured to register merchandise to be purchased by a customer in a sales transaction and receive a designation of services to be applied to the registered merchandise after settlement of the sales transaction. The processor stores the designation of services in association with the registered merchandise and outputs a list of the registered merchandise associated with the designated services to be applied after settlement of the sale transaction.

Certain example embodiments will be described below with reference to the drawings.

### First Embodiment

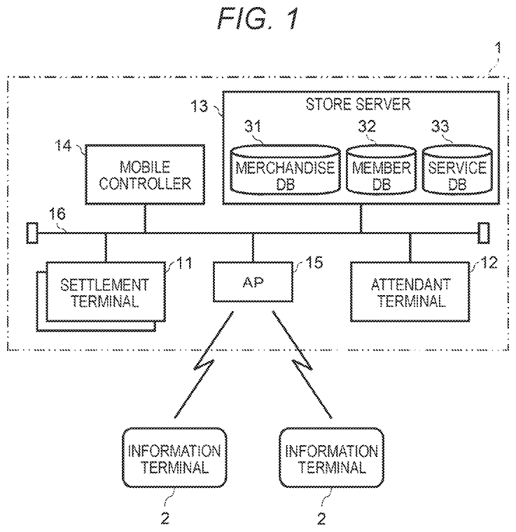

A first embodiment is a merchandise registration system 1 as depicted in FIG. 1. The merchandise registration system 1 that can provide improved efficiency of operations related to services executed after checkout at a service counter, for example. The merchandise registration system 1 is a system constructed in a store in which each customer uses an information terminal 2 to register merchandise to be purchased by himself/herself. In this type of merchandise registration system 1, for example, a smartphone owned by each consumer who is a customer, a mobile terminal owned by the store but lent to a customer, a tablet-type cart terminal attached to a shopping cart, or the like can be the information terminal 2. In the present embodiment, a case where a smartphone is used as the information terminal 2 is exemplified. There are various possible services that may be available to customers at service counters, but in the present embodiment, a delivery service for delivering the merchandise purchased by customers to their homes and a packaging service for packaging the merchandise will be used as examples of such various services.

Description of Merchandise Registration System

FIG. 1 is a block diagram showing a schematic configuration of the merchandise registration system 1. The merchandise registration system 1 includes a settlement terminal 11, an attendant terminal 12, a store server 13, a mobile controller 14, and an access point 15. The merchandise registration system 1 also includes a communication network 16 such as a LAN (Local Area Network), and the settlement terminal 11, the attendant terminal 12, the store server 13, the mobile controller 14, and the access point 15 are connected to the communication network 16 to constitute the merchandise registration system 1. The communication network 16 may be wired or wireless. Further, the communication network 16 may use both wired and wireless.

The settlement terminal 11 is a device for processing the payment of the price by the customer and settling the sales transaction with the customer. The settlement terminal 11 may be operated by a customer or by a store clerk. The settlement terminal 11 is called, for example, a POS (Point Of Sales) terminal, a checkout machine, or the like. The settlement terminal 11 is installed in a checkout place provided separately from a sales floor where merchandise is displayed. The number of installed settlement terminals 11 is not particularly limited.

The attendant terminal 12 is a device that has the function of displaying the monitoring image of the settlement terminal 11 on a display device. The attendant terminal 12 is installed near the exit of the checkout place. At the place where the attendant terminal 12 is installed, a store clerk called an attendant in this context is stationed. The monitoring image changes according to the input operations at the settlement terminal 11. The attendant monitors for erroneous operation, unauthorized operation, or the like by the customer based on the information presented in the monitoring image.

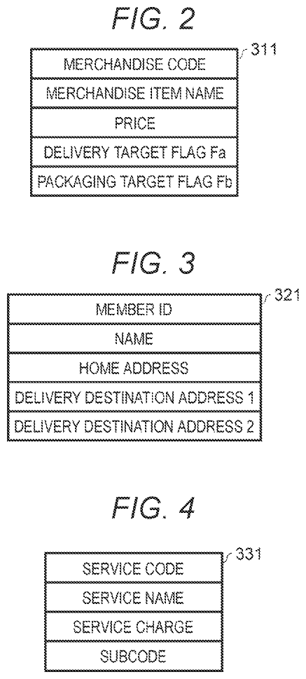

The store server 13 is a computer that supports overall store operations. For that support, the store server 13 manages various databases such as a merchandise database 31, a member database 32, a service database 33, and the like. The merchandise database 31 is a collection of merchandise records 311 (see FIG. 2) generated for each merchandise sold at the store. The member database 32 is a collection of member records 321 (see FIG. 3) generated for each consumer who is a member. The service database 33 is a collection of service records 331 (see FIG. 4) generated for each type of service available at the service counter to consumers who purchased merchandise at the store, so-called customers. Details of the merchandise record 311, member record 321, and service record 331 will be described later.

The access point 15 is a device that receives a connection request from the information terminal 2 as a terminal of the communication network 16 and relays communication to devices on the communication network 16. The access point 15 is installed in the store so that connection requests from the information terminal 2 can be received throughout the sales floor. A plurality of access points 15 may be distributed and installed in the store so as not to cause blind spots in communication.

The mobile controller 14 can be a computer that performs two-way data communication with the information terminal 2 (connected via the access point 15) to process information so that the information terminal 2 functions as a merchandise registration machine. The mobile controller 14 is one example of a merchandise registration device.

FIG. 2 is a schematic diagram showing the data structure of the merchandise record 311. The merchandise record 311 includes merchandise data such as a merchandise code, merchandise name, and price, as well as a delivery target flag Fa and a packaging target flag Fb. The merchandise code is a unique identification code set for each merchandise to individually identify the merchandise. Each merchandise is usually provided with a barcode representing a merchandise code. Some merchandise, such as perishables, may not have barcodes. An in-store code based on a code system unique to a company or store is set for the merchandise that does not have a barcode.

The delivery target flag Fa is 1-bit data for identifying whether or not the merchandise can be the target merchandise for the delivery service. For example, frozen foods and some other perishables might not be the target merchandise for the delivery service. In the present embodiment, the delivery target flag Fa value for indicating that the merchandise can be the target merchandise of the delivery service is set to “1”, and the delivery target flag Fa value for indicating that the merchandise can not be the target merchandise is set to “0”.

The packaging target flag Fb is 1-bit data for identifying whether or not the merchandise can be the target merchandise for the packaging service. For example, some large items might not be the target merchandise for the packaging service. In the present embodiment, the packaging target flag Fb value indicating that the merchandise can be the target merchandise for the packaging service is set to “1”, and the packaging target flag Fb value for indicating that the merchandise can not be the target merchandise is set to “0”.

FIG. 3 is a schematic diagram showing the data structure of the member record 321. The member record 321 includes member data entries such as a member ID, name, and home address, as well as a delivery address other than the home address. The member ID is a unique identification code set for each member. For example, a member is provided with a membership card that records information associated with his/her member ID. Alternatively, the member may have installed a member-dedicated application (application software) capable of displaying a barcode or two-dimensional code associated with his/her member ID on an information terminal 2 such as a smartphone.

The delivery address is an address other than the home address that was designated as the delivery destination when the delivery service was used in the past. Therefore, for the member record 321 of a member who has not previously used the delivery service to deliver merchandise to places other than a home address, the delivery address entries may be empty. In the member record 321 of the member who has had merchandise delivered to a plurality of different locations other than a home address, a plurality of delivery addresses may be described. By setting a plurality of delivery addresses in this way, the member can select a desired delivery address from among the stored plurality of delivery addresses.

FIG. 4 is a schematic diagram showing the data structure of the service record 331. The service record 331 includes entries for a service code, a service name, a service charge, and a subcode. The service code is a unique identification code set for each type of service available to customers at the service counter. The service name is the name of the service identified by the service code, and the service charge is the cost of the service. The subcode is a code for specifying a second service that is linked to the first service identified by the service code. A service record 331 in which the subcode value is listed as the service code is also included in the service database 33 as another service record entry.

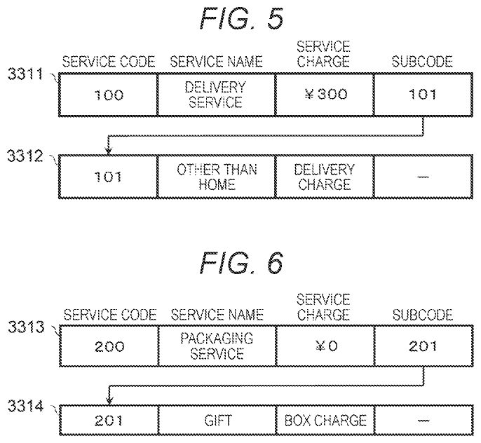

A specific example of the service record 331 will be described using FIGS. 5 and 6.

FIG. 5 is an example of the service record 331 relating to the delivery service. In the present embodiment, the delivery service is home delivery by default, and the service charge for the standard home delivery is 300 yen. However, it is possible for the customer to choose to deliver to a place other than home, in which case a delivery charge may be collected in addition to the standard service charge. A first service record 3311 and a second service record 3312 are registered in the service database 33 for such a delivery service. The first service record 3311 is a record relating to home delivery service, and has “100” as the service code, “delivery service” as the service name, and “¥300” as the service charge. Also, the service code “101” of the second service record 3312 is described as a possible subcode. The second service record 3312 is a record relating to a delivery service to a place other than home, and has “101” as the service code, “other than home” as the service name, and “delivery charge” as the service charge. No subcode is written in the second service record 3312. As for the delivery charge, a uniform amount may be used, or the delivery charge for each delivery address may be determined by referring to a data table in which delivery charges are set for different regions.

FIG. 6 is an example of the service record 331 related to packaging services. In the present embodiment, the packaging service is simple packaging by default. With simple packaging, the merchandise is packaged in basic wrapping paper, and the service charge is free (zero). With this packaging service, gift wrapping of the merchandise in a special box or the like is also available. If the customer selects the gift wrapping option, a box charge will be collected. A third service record 3313 and a fourth service record 3314 are registered in the service database 33 for such a packaging service. The third service record 3313 is a record relating to the simple packaging service, and has “200” as the service code, “simple packaging” as the service name, and “¥0” as the service charge. Also, the service code “201” of the fourth service record 3314 is listed as a possible subcode. The fourth service record 3314 is a record relating to the gift wrapping service, and has “201” as the service code, “gift” as the service name, and “box charge” as the service charge. No subcode is written in fourth service record 3314. The box charge may be a uniform amount or the box charge may vary according to the merchandise to be packaged and determined by referring to a data table in which various box charges are set for different merchandise.

Description of Configuration of Information Terminal

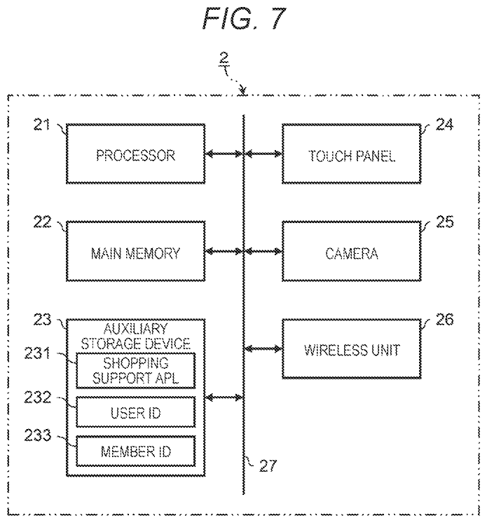

FIG. 7 is a block diagram showing the configuration of the information terminal 2. The information terminal 2 includes a processor 21, a main memory 22, an auxiliary storage device 23, a touch panel 24, a camera 25, a wireless unit 26, a system transmission line 27, and the like. The system transmission line 27 includes an address bus, a data bus, control signal lines, and the like. The system transmission line 27 connects the processor 21 and other units directly or via a signal input and output circuit, and transmits data signals exchanged therebetween.

The processor 21 controls components to implement various described functions of the information terminal 2 according to an operating system and/or application program. The processor 21 is, for example, a CPU (Central Processing Unit).

The main memory 22 includes a non-volatile memory area and a volatile memory area. The main memory 22 stores the operating system or application programs in the non-volatile memory area. The main memory 22 may store data necessary for the processor 21 to execute processing for controlling each unit in the non-volatile or volatile memory area. The main memory 22 uses the volatile memory area as a work area in which data is appropriately rewritten by the processor 21. The non-volatile memory area is, for example, a ROM (Read Only Memory). The volatile memory area is, for example, a RAM (Random Access Memory).

For example, an EEPROM (Electric Erasable Programmable Read-Only Memory), an SD memory card, or the like can serve as the auxiliary storage device 23 of the information terminal 2. The auxiliary storage device 23 stores data used when the processor 21 performs various types of processing, data generated by processing of the processor 21, and the like. The auxiliary storage device 23 may store application programs and the like.

The touch panel 24 is a device that combines an input device and a display device. The touch panel 24 displays information to the operator of the information terminal 2 and receives operation input by the operator. Operators are typically customers shopping at the store.

The camera 25 is an imaging device mounted on the information terminal 2. The camera 25 operates according to an application program installed in the information terminal 2 as a device for taking still images or moving images, or as a device for scanning data codes such as barcodes or two-dimensional codes. The camera 25 is one example of a code reader.

The wireless unit 26 is a circuit for performing data communication with the access point 15 according to the wireless LAN communication protocol.

The information terminal 2 having such a configuration has a shopping support program 231 installed in the auxiliary storage device 23 so that the information terminal 2 can be used in the merchandise registration system 1. The shopping support program 231 is a kind of application software and is installed in the information terminal 2 using the Internet or the like. The information terminal 2 in which the shopping support program 231 is installed uses part of the storage area of the auxiliary storage device 23 as a user ID area 232 and a member ID area 233.

The user ID area 232 is an area for storing a unique user ID set for each user to individually identify the user of the information terminal 2. A different user ID is stored in the user ID area 232 of each information terminal 2 in which the shopping support program 231 is installed. A user ID stored in the user ID area 232 of one information terminal 2 does not overlap with a user ID stored in the user ID area 232 of another information terminal 2. A user may be referred to as a consumer, customer, member, or the like in the present specification.

The member ID area 233 is an area for storing the member ID set for each member. One of the functions of the shopping support program 231 is a cooperation function with the member ID. The member ID is stored in the member ID area 233 if a member who is the user of the information terminal 2 registers his/her own member ID using this cooperation function. If the user does not use the cooperation function, the member ID is not stored in the member ID area 233.

Description of Configuration of Settlement Terminal

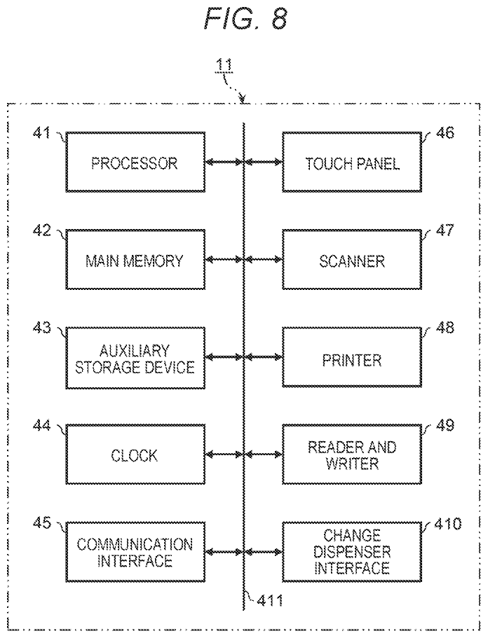

FIG. 8 is a block diagram showing the configuration of the settlement terminal 11. The settlement terminal 11 includes a processor 41, a main memory 42, an auxiliary storage device 43, a clock 44, a communication interface 45, a touch panel 46, a scanner 47, a printer 48, a reader and writer 49, a change dispenser interface 410, a system transmission line 411, and the like. The system transmission line 411 includes an address bus, a data bus, a control signal line, and the like. The system transmission line 411 connects the processor 41 and other units directly or via a signal input and output circuit, and transmits data signals exchanged therebetween.

The settlement terminal 11 connects the processor 41, the main memory 42, the auxiliary storage device 43, the clock 44, and the communication interface 45 via the system transmission line 411. The settlement terminal 11 connects to device interfaces or otherwise incorporates devices such as the touch panel 46, the scanner 47, the printer 48, the reader and writer 49, the change dispenser interface 410, and the like via the system transmission line 411.

The processor 41 controls components to implement various described functions of the settlement terminal 11 according to an operating system and/or an application program. The processor 41 is, for example, a CPU.

The main memory 42 includes a non-volatile memory area and a volatile memory area. The main memory 42 stores the operating system or application programs in the non-volatile memory area. The main memory 42 may store data necessary for the processor 41 to control each part in the non-volatile or volatile memory area. The main memory 42 uses the volatile memory area as a work area in which data is appropriately rewritten by the processor 41. The non-volatile memory area is, for example, a ROM. The volatile memory area is, for example, a RAM.

For example, an EEPROM, an HDD (Hard Disk Drive), an SSD (Solid State Drive), or the like can be the auxiliary storage device 43 of the settlement terminal 11. The auxiliary storage device 43 stores data used when the processor 41 performs various types of processing, data generated by processing in the processor 41, and the like. The auxiliary storage device 43 may store application programs.

The clock 44 tracks the date and time. The processor 41 processes the date and time tracked by the clock 44 as the current date and time.

The communication interface 45 is a circuit for performing data communication with the store server 13, the mobile controller 14, and the like, which are connected via the communication network 16.

The touch panel 46 is a device that combines an input device and a display device. The touch panel 46 displays information to the operator of the settlement terminal 11 and receives operation input by the operator. The operator may be a customer or a store clerk.

The scanner 47 is an example of a reading device that reads code symbols such as barcodes or two-dimensional codes. The scanner 47 may be of a type that reads code symbols by scanning laser light or may be of a type that reads code symbols from an image captured by an imaging device.

The printer 48 dispenses a purchase receipt by printing various text, character strings, or images on the receipt paper. The purchase receipt is a receipt on which the merchandise names, prices, total price, and the like related to the merchandise purchased by the customer are printed. As this type of printer 48, for example, a thermal printer, a dot impact printer, or the like can be used. The settlement terminal 11 may have an electronic receipt function for digitizing receipt data and providing the digitized receipt data to the customer.

The reader and writer 49 has a function of reading data recorded on media such as cards and smartphones, and a function of writing data to the media. Cards may include membership cards called in-house point cards, shared point cards, reward point cards, and the like, in addition to settlement cards such as credit cards, debit cards, electronic money cards, and prepaid cards. The reader and writer 49 may be a magnetic, contact, or non-contact device, and may include multiple types of devices.

The change dispenser interface 410 provides an interface for an automatic change dispenser. The change dispenser interface 410 receives the amount data of the money inserted into the automatic change dispenser from the automatic change dispenser. The change dispenser interface 410 outputs change data from the settlement terminal 11 to the automatic change dispenser. The automatic change dispenser automatically dispenses money corresponding to the change data as change.

The settlement terminal 11 having such a hardware configuration can perform cash settlement processing in which settlement of sales transactions with customers is made using cash inserted into the automatic change dispenser, credit settlement processing in which the settlement is made using a credit card read by the reader and writer 49, electronic money settlement processing in which the settlement is made using electronic money identified by the electronic money ID read by the scanner 47 or the reader and writer 49, and code settlement processing in which the settlement is made using a barcode or two-dimensional code read by the scanner. In general, cash settlement processing, credit settlement processing, electronic money settlement processing, and code settlement processing are well-known processing, and the additional description thereof will be omitted.

Description of Configuration of Mobile Controller

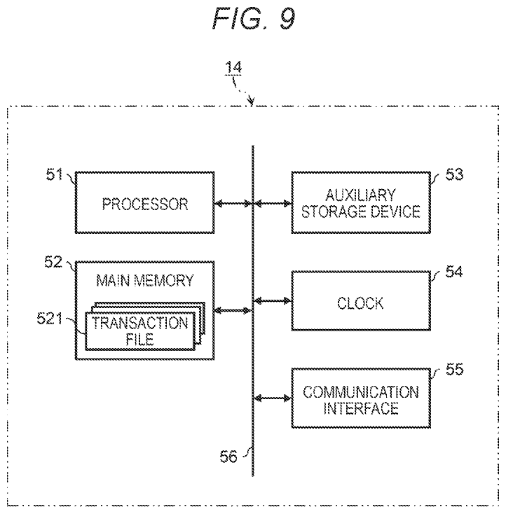

FIG. 9 is a block diagram showing the configuration of the mobile controller 14. The mobile controller 14 includes a processor 51, a main memory 52, an auxiliary storage device 53, a clock 54, a communication interface 55, a system transmission line 56, and the like. The system transmission line 56 includes an address bus, a data bus, control signal lines, and the like. The system transmission line 56 connects the processor 51 and other units directly or via a signal input and output circuit, and transmits data signals exchanged therebetween.

The mobile controller 14 connects the processor 51, the main memory 52, the auxiliary storage device 53, the clock 54, and the communication interface 55 via the system transmission line 56.

The processor 51 controls components to implement various described functions of the mobile controller 14 according to an operating system and/or application program. The processor 51 is, for example, a CPU.

The main memory 52 includes a non-volatile memory area and a volatile memory area. The main memory 52 stores the operating system or application programs in the non-volatile memory area. The main memory 52 may store data necessary for the processor 51 to execute processing for controlling each unit in the non-volatile or volatile memory area. The main memory 52 uses the volatile memory area as a work area in which data is appropriately rewritten by the processor 51. The non-volatile memory area is, for example, a ROM. The volatile memory area is, for example, a RAM.

For example, an EEPROM, an HDD, an SSD, or the like can be the auxiliary storage device 53 of the mobile controller 14. The auxiliary storage device 53 stores data used when the processor 51 performs various types of processing, data generated by processing in the processor 51, and the like. The auxiliary storage device 53 may store application programs.

The clock 54 tracks the date and time. The processor 51 processes the date and time tracked by the clock 54 as the current date and time.

The communication interface 55 is a circuit for performing data communication with the settlement terminal 11, the attendant terminal 12, the store server 13, the access point 15, and the like, which are connected via the communication network 16.

The mobile controller 14 with such a configuration uses part of the volatile memory area of the main memory 52 as a storage area for a transaction file 521. The transaction file 521 is a data file generated for each customer who is a so-called self-managing customer who uses the information terminal 2 to register the merchandise to be purchased by himself/herself.

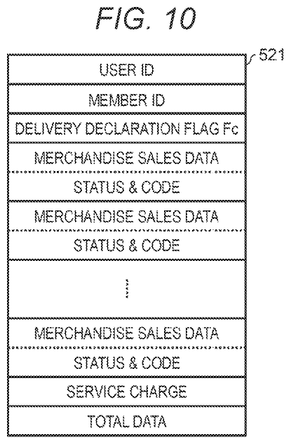

FIG. 10 is a schematic diagram showing the main data items stored in the transaction file 521. As shown in FIG. 10, the transaction file 521 stores at least a user ID, a member ID, a delivery declaration flag Fc, one or more merchandise sales data, a service status and service code, which are associated with the merchandise sales data, a service charge, and total data.

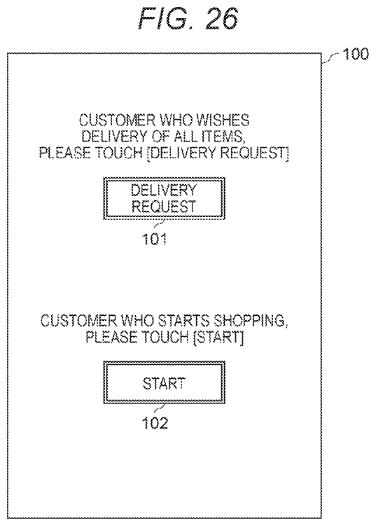

The delivery declaration flag Fc is 1-bit data for identifying whether or not the delivery service is requested for all the merchandise items purchased by the customer at the store. In the present embodiment, the delivery declaration flag Fc is set to “1” if the delivery service is requested for all items. A user requesting a delivery service for all items enters a delivery request key from a start screen 100 (see FIG. 26) displayed on the touch panel 24 of the information terminal 2 before starting shopping at the store. By such an operation, the delivery declaration flag Fc of the transaction file 521 storing the customer's user ID becomes “1”.

Merchandise sales data is data related to sale of the merchandise registered via the information terminal 2. The items of merchandise that have been registered by the customer can be referred to as registered merchandise. The merchandise sales data includes a merchandise code, a merchandise name, a price, a sales quantity, a sales amount of money, a delivery target flag Fa, a packaging target flag Fb, and the like.

The service status and service code are examples of service data related to services applied to registered merchandise. In the present embodiment, there are two types of services applied to registered merchandise: a delivery service and a packaging service. Therefore, in the present embodiment, the service status is two digits: the tens digit is information related to the delivery service and the ones digit is information related to the packaging service. Specifically, the tens digit of the service status for the registered merchandise to which the delivery service is applied is set to “1”, and the tens digit of the service status for the registered merchandise to which the delivery service is not applied is set to “0”. Similarly, the ones digit of the service status for the registered merchandise to which the packaging service is applied is set to “1”, and the ones digit of the service status for the registered merchandise to which the packaging service is not applied is set to “0”. Incidentally, if there are three or more types of services applied to the registered merchandise, the number of digits of the service status only needs to be matched with the number of types of service.

The service code is as described using FIGS. 4 to 6. That is, the service code is “100” for the registered merchandise to which the home delivery service is applied, and the service code is “101” for the registered merchandise to which the delivery service to a place other than home is applied. Similarly, the registered merchandise to which the simple packaging service is applied has a service code of “200”, and the registered merchandise to which the gift wrapping service is applied has a service code of “201”. Hereinafter, a service code related to the delivery service will be referred to as a delivery code, and a service code related to the packaging service will be referred to as a packaging code.

The service charge is the total cost of the service applied to the registered merchandise. If there is a delivery charge or box charge for the applicable service, that charge will also be added to the service charge.

The total data includes total quantity data and total price data for registered merchandise. The total quantity data is the sum of the sales quantities of the merchandise sales data stored in the transaction file 521, and the total price data is the sum of the sales amount of money in the merchandise sales data. If there is a service charge to be applied to the registered merchandise for a customer requested service, the service charge will be added to the total price.

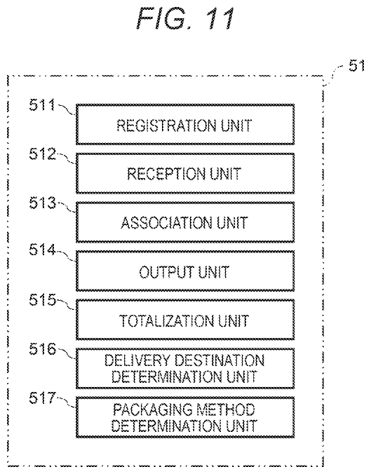

FIG. 11 is a schematic diagram for illustrating functions of the processor 51. The mobile controller 14 is has a control program that when executed causes the processor 51 provide the described functions of a registration unit 511, a reception unit 512, an association unit 513, an output unit 514, a totalization unit 515, a delivery destination determination unit 516, and a packaging method determination unit 517. The control program is a kind of application program stored in the main memory 52 or the auxiliary storage device 53. The method of installing the control program in the main memory 52 or the auxiliary storage device 53 is not particularly limited. The control program can be recorded on a removable recording medium or distributed via the communication network 16 and installed in the main memory 52 or the auxiliary storage device 53. The recording medium may be of any form, such as a CD-ROM, a memory card, and the like, as long as the recording medium can store the program and can be read by the device.

The registration unit 511 provides a function of registering merchandise to be purchased. The registration unit 511 registers merchandise sales data related to the merchandise to be purchased in the transaction file 521 based on the data from the information terminal 2 operated by the customer.

The reception unit 512 provides a function of receiving designations of services to be applied to the merchandise after checkout. The reception unit 512 receives designations of different types of services via the information terminal 2. In the present embodiment, the reception unit 512 receives a delivery service request and/or a packaging service request.

The association unit 513 provides a function of storing the merchandise registered by the registration unit 511 and the service to be applied to the merchandise in association with each other. The association unit 513 stores the service data associated with the merchandise sales data registered in the transaction file 521, that is, the service status and the service code (delivery code, packaging code) on the transaction file 521.

The output unit 514 provides a function of outputting the merchandise and services associated by the association unit 513. The output unit 514 outputs the merchandise sales data and the service data to the settlement terminal 11 that performs the settlement of the merchandise that has been registered by the registration unit 511. The output unit 514 may output the merchandise sales data and the service data to the settlement terminal 11 via the store server 13, for example. In other examples, if the information terminal 2 itself has a settlement function, the output unit 514 may output the merchandise sales data and the service data to the information terminal 2 and utilize the merchandise sales data and the service data for the settlement processing on the information terminal 2.

The totalization unit 515 provides a function of summing the charges for the service requests received by the reception unit 512 and the price of the merchandise registered by the registration unit 511. For example, in the settlement terminal 11, settlement processing is performed for the sum total of the prices of the merchandise and the service charges.

The delivery destination determination unit 516 provides a function of identifying the delivery destination of the target merchandise if the delivery service request is received by the reception unit 512. As the delivery destination in this example, the choices are home and a place other than home as described above.

The packaging method determination unit 517 provides a function of identifying the packaging method for the target merchandise if the packaging service request is received by the reception unit 512. As described above, the choices are simple packaging and gift wrapping as possible packaging methods.

Description of Operation of Merchandise Registration

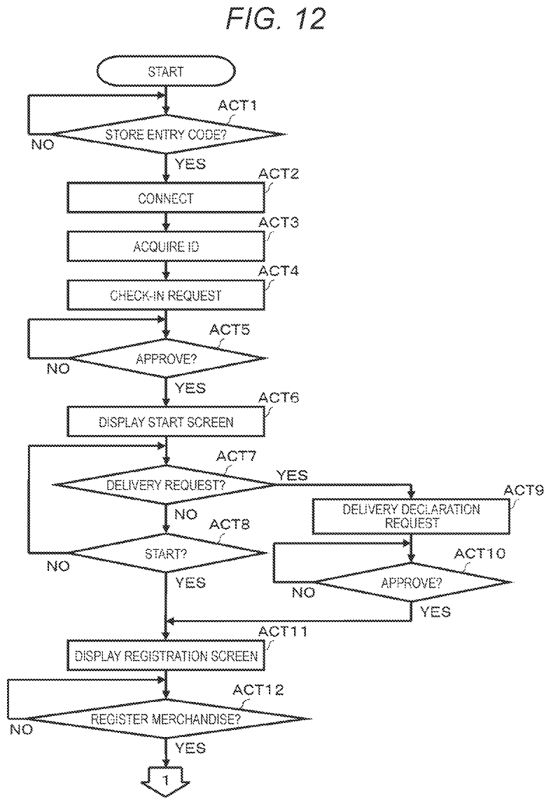

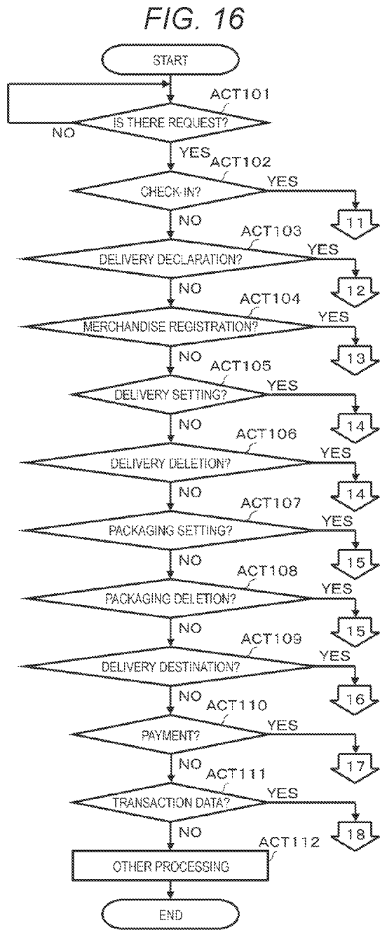

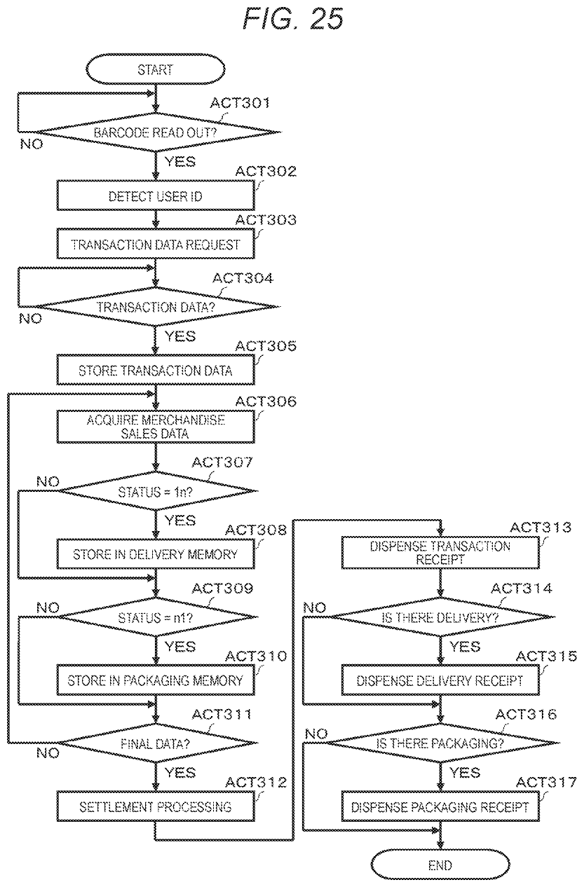

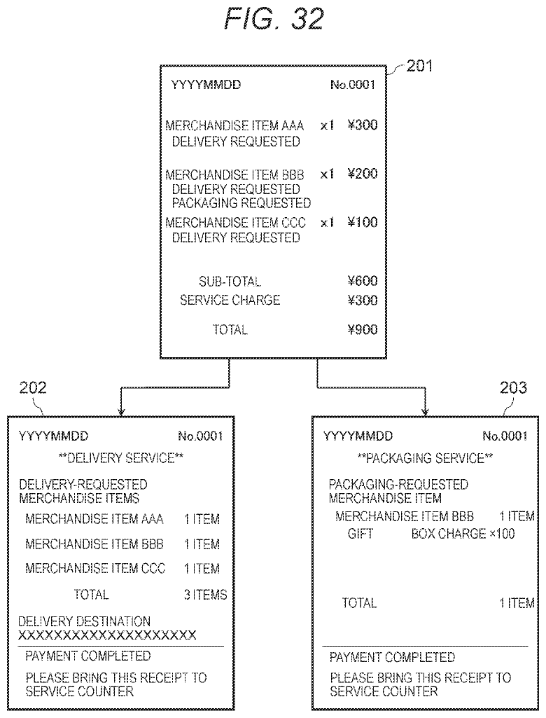

FIGS. 12 to 15 are flowcharts showing the procedures of processing executed by the processor 21 of the information terminal 2 according to the shopping support program 231. FIGS. 16 to 24 are flowcharts showing the procedures of processing executed by the processor 51 of the mobile controller 14 according to a control program. FIG. 25 is a flowchart showing the procedure of processing executed by the processor 41 of the settlement terminal 11 according to a program. FIGS. 26 to 31 are schematic diagrams showing display examples of screens displayed on the touch panel 24 of the information terminal 2. FIG. 32 is a schematic diagram of receipts dispensed from the settlement terminal 11. The certain operations of the merchandise registration system 1 will be described below with reference to these drawings. The specific content of the operation example described below is non-limiting. As long as similar results can be obtained, the details of operation procedure and contents are not particularly limited. Further, the layout and format of the screen display and receipt printing, text data, and the like are also examples and can be changed as appropriate.

<Description of Operation of Information Terminal>

First, the flowcharts of FIGS. 12 to 15 and the screen examples of FIGS. 26 to 31 are used to describe the certain operations of the information terminal 2 when a customer who registered the merchandise to be purchased by himself/herself using the information terminal 2 uses a delivery service or a packaging service after checkout.

Once the shopping support program 231 is started, the processor 21 of the information terminal 2 starts processing of the procedures shown in the flowcharts of FIGS. 12 to 15. First, the processor 21 waits for a store entry code to be input, as ACT 1. The store entry code is obtained by encoding the setting information related to the store in a predetermined two-dimensional code system, and is prepared, for example, at the entrance of the store. The setting information includes, for example, parameters necessary for the information terminal 2 to communicate with the access point 15 using the wireless LAN, information related to operation restrictions of the information terminal 2, and the like. A customer who visits the store reads the store entry code with the camera 25 of the information terminal 2.

If the store entry code is read by the camera 25, the processor 21 controls the wireless unit 26 and connects with the access point 15 using the wireless LAN, as ACT 2. Then, when connected to the access point 15, the processor 21 acquires the user ID from the user ID area 232, as ACT 3. The processor 21 also acquires the member ID if the member ID is stored in the member ID area 233.

The processor 21 controls the wireless unit 26 to transmit the check-in request command, as ACT 4. By this control, a check-in request command is wirelessly transmitted via the wireless unit 26. The check-in request command is received at the access point 15 and transmitted to the mobile controller 14 via the communication network 16. The check-in request command includes a user ID. Further, if a member ID is also acquired together with the user ID, the member ID is also included in the check-in request command.

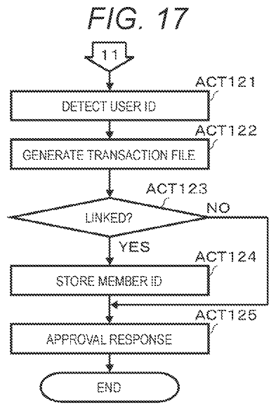

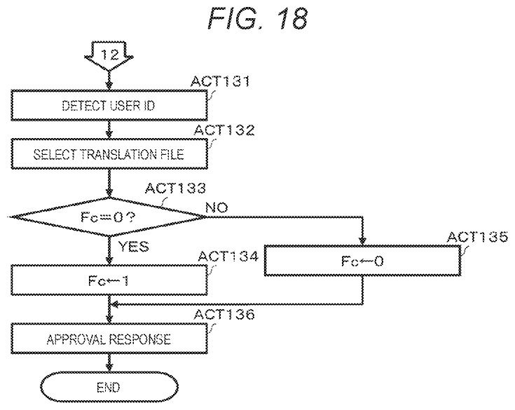

The processor 21 waits for an approval response command, as ACT 5, after sending the check-in request command. As will be described later with reference to FIG. 17, the mobile controller 14 returns an approval response command after receiving the check-in request command. After the processor 21 receives the approval response command via the wireless unit 26, the screen of the touch panel 24 becomes the start screen 100 (see FIG. 26), as ACT 6.

FIG. 26 is a schematic diagram showing a display example of the start screen 100. The start screen 100 has two soft keys: a delivery request key 101 and a start key 102. The delivery request key 101 is pressed by customers who wants to request the delivery service for all merchandise items purchased at the store. The start key 102 is pressed when the customer starts shopping at the store.

The processor 21 displaying the start screen 100 waits for input of the delivery request key 101, as ACT 7, or input of the start key 102, as ACT 8. If the delivery request key 101 is selected in the standby state of ACT 7 and ACT 8, the processor 21 proceeds from ACT 7 to ACT 9. The processor 21 controls the wireless unit 26 to transmit a delivery declaration request command, as ACT 9. By this control, a delivery declaration request command is wirelessly transmitted via the wireless unit 26. The delivery declaration request command is received at the access point 15 and transmitted to the mobile controller 14 via the communication network 16. The delivery declaration request command includes a user ID.

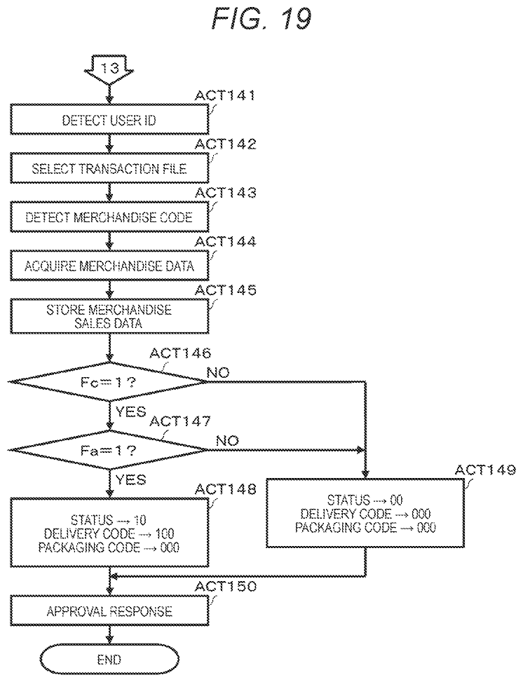

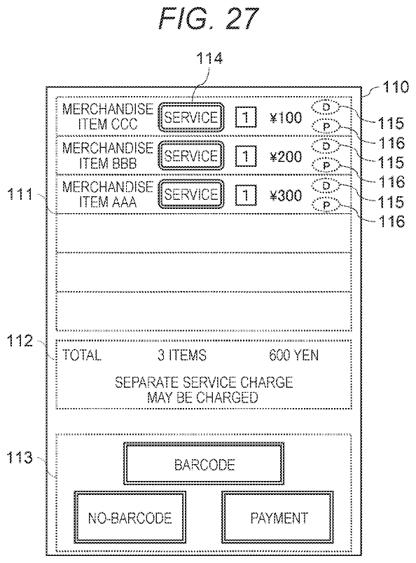

The processor 21 waits for an approval response command, as ACT 10, after transmitting the delivery declaration request command. As will be described later with reference to FIG. 18, the mobile controller 14 returns an approval response command after receiving the delivery declaration request command. After the processor 21 receives the approval response command via the wireless unit 26, the screen of the touch panel 24 becomes a registration screen 110 (see FIG. 27), as ACT 11.

If the start key 102 is selected in the standby state of ACT 7 and ACT 8, the processor 21 proceeds from ACT 8 to ACT 11. The processor 21 uses the screen of the touch panel 24 as the registration screen 110, as ACT 11. If the customer presses the delivery request key 101 or the start key 102 on the start screen 100, the screen of the touch panel 24 transitions from the start screen 100 to the registration screen 110.

FIG. 27 is a schematic diagram showing a display example of the registration screen 110. The registration screen 110 includes a registered merchandise detail area 111, a total area 112, and an operation key area 113. In the detail area 111, detailed data such as the merchandise name, the sales quantity, the sales amount of money, and the like of the merchandise registered by operating the information terminal 2 are displayed. The total area 112 displays the total quantity and total price of the registered merchandise. At the time of ACT 11, no information is displayed in the detail area 111 and the total area 112 because no merchandise was registered.

In the operation key area 113, a barcode key, no barcode key, and a payment key are displayed as soft keys. The barcode key is selected by a customer when registering merchandise with a barcode. If the barcode key is pressed, the camera 25 is started, and thus, the customer can scan the barcode attached to the merchandise with the camera 25. The no-barcode key is selected by a customer when registering an item of merchandise without a barcode. If the no-barcode key is pressed, a list of merchandise without a barcode attached is displayed on the touch panel 24, and the customer selects the item to be purchased from the list. The payment key is selected when a customer who has finished shopping declares an intention to make payment of the price.

The processor 21 that displayed the registration screen 110 waits for the registration operation of the merchandise purchased by the customer, as ACT 12. The merchandise registration operation is an operation of inputting a barcode key and scanning the barcode of the merchandise with the camera 25 or an operation of inputting a no-barcode key and selecting merchandise without a barcode from the merchandise list. Through such a merchandise registration operation, the processor 21 can acquire the merchandise code of the registered merchandise.

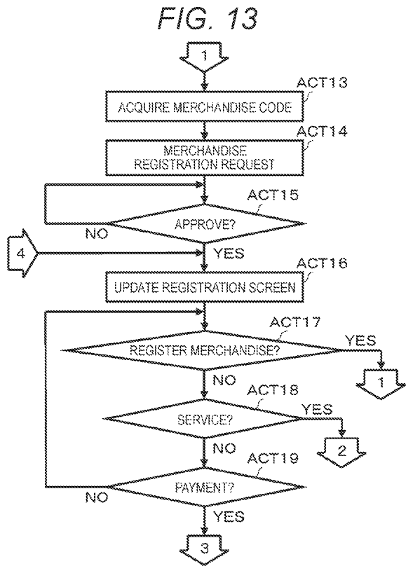

Upon confirming the registration screen 110, the customer starts shopping. Then, if the customer finds merchandise that the customer wishes to purchase from among the merchandise displayed on the sales floor, the customer performs a registration operation of the merchandise on the information terminal 2. In ACT 12, if the merchandise registration operation is performed, the processor 21 proceeds to ACT 13 in FIG. 13. The processor 21 acquires the merchandise code of the registered merchandise, as ACT 13. For example, if there is a registration operation by entering the barcode key, the merchandise code of the registered merchandise is acquired from the barcode. For example, if there is a registration operation by entering the no-barcode key, the merchandise code of the registered merchandise selected from the list is acquired.

The processor 21 that acquired the merchandise code of the registered merchandise controls the wireless unit 26 to transmit a merchandise registration request command, as ACT 14. By this control, the merchandise registration request command is wirelessly transmitted via the wireless unit 26. The merchandise registration request command is received at the access point 15 and transmitted to the mobile controller 14 via the communication network 16. The merchandise registration request command includes the user ID and the merchandise code of the registered merchandise.

The processor 21 waits for an approval response command, as ACT 15, after transmitting the merchandise registration request command. As will be described later with reference to FIG. 19, the mobile controller 14 returns an approval response command after receiving the merchandise registration request command. The approval response command includes data of the transaction file 521 generated for the customer identified by the user ID. The processor 21 receives and stores the data of the transaction file 521 in the main memory 22, as ACT 16. The processor 21 then updates the data in the detail area 111 and the total area 112 of the registration screen 110 based on the data in the transaction file 521.

FIG. 27 exemplifies the registration screen 110 after the customer registered one merchandise item AAA with a unit price of 300 yen, one merchandise item BBB with a unit price of 200 yen, and one merchandise item CCC with a unit price of 100 yen. In the detail area 111, the merchandise name, the sales quantity, and the sales amount of money are displayed as detailed data of the registered merchandise for each line. The total area 112 displays the total quantity and the total price as total data. The customer can change the sales quantity by touching the sales quantity in the detailed data. By changing the sales quantity, the sales amount of money in the detailed data is also updated. Also, the total quantity and the total price are updated.

In the detail area 111, a service key 114 is displayed for each detailed data. The service key 114 is selected by the customer if a delivery service or a packaging service is to be applied to the purchased merchandise. The service key 114 is an example of an individual instruction unit that individually indicates the request for services for a registered item of merchandise. For example, if the delivery service is to be applied to the merchandise item AAA, the customer presses the service key 114 of the line where the detailed data of the merchandise item AAA is displayed. If a packaging service is to be applied to the merchandise item BBB, the customer presses the service key 114 of the line where the detailed data of the merchandise item BBB is displayed.

Also, in the detail area 111, a delivery service mark 115 and a packaging service mark 116 can be separately displayed for each line. The delivery service mark 115 is displayed if a delivery service request can be received for the item of merchandise whose detailed data is displayed on the same line. The packaging service mark 116 is displayed if a packaging service request can be received for the item of merchandise whose detailed data is displayed on the same line.

Referring back to FIG. 13, after updating the registration screen, processor 21 waits for a merchandise registration operation as ACT 17, the pressing of the service key 114 as ACT 18, or the pressing of the payment key as ACT 19. In the standby state of ACT 17 to ACT 19, if a merchandise registration operation is performed with the barcode key or no-barcode key, the processor 21 returns to ACT 13. The processor 21 executes the processing of ACT 13 to ACT 16 in the same manner as described above. Then, the processor 21 again enters a standby state for ACT 17 to ACT 19.

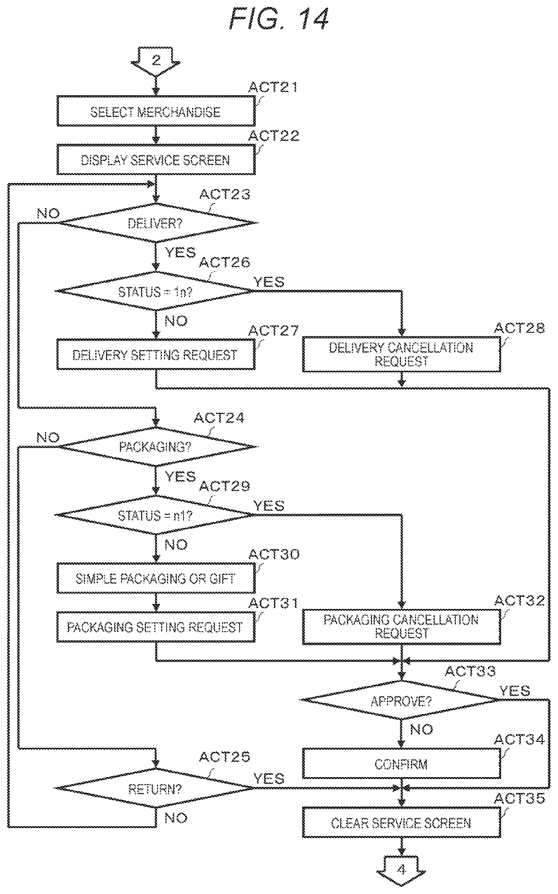

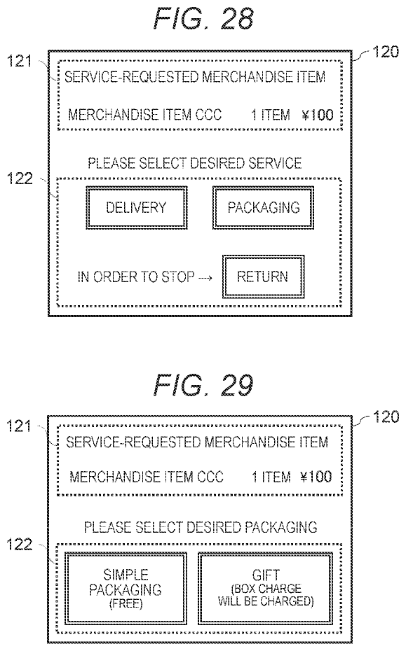

If the service key 114 is pressed in the standby state of ACT 17 to ACT 19, the processor 21 proceeds from ACT 18 to ACT 21 in FIG. 14. The processor 21 selects the merchandise specified by the detailed data of the line displaying the service key 114 input as the service-requested merchandise, as ACT 21. For example, in FIG. 27, if the service key 114 displayed on the same line as the detailed data of the merchandise CCC is selected, the processor 21 selects the merchandise CCC as the service-requested merchandise. Then, the processor 21 displays a service screen 120 (see FIG. 28) on the touch panel 24, as ACT 22. The service screen 120 is displayed as a popup over the registration screen 110.

FIG. 28 is a schematic diagram showing a display example of the service screen 120. The service screen 120 includes a service-requested merchandise detail area 121 and an operation key area 122. The detail area 121 displays the merchandise name, the sales quantity, the sales amount of money, and the like of the service-requested merchandise. A delivery key, a packaging key, and a return key are displayed as soft keys in the operation key area 122. The delivery key is selected if the customer requests a delivery service. The packaging key is selected if the customer requests the packaging service. The return key is selected if the customer cancels the service request.

The processor 21 that displayed the service screen 120 waits for the input of the delivery key as ACT 23, the input of the packaging key as ACT 24, or the input of the return key as ACT 25. In the standby state of ACT 23 to ACT 25, if the return key is pressed, the processor 21 proceeds from ACT 25 to ACT 35. As ACT 35, the processor 21 clears the service screen 120 and returns to ACT 16 of FIG. 13.

In the standby state of ACT 23 to ACT 25, if the delivery key is pressed, the processor 21 proceeds from ACT 23 to ACT 26. As ACT 26, the processor 21 refers to the data of the transaction file 521 stored in the main memory 22, and checks whether the tens digit in the service status of the service data associated with the merchandise sales data of the service-requested merchandise is “1”. If the tens digit in the service status is “0”, the delivery service is not yet requested for the service-requested merchandise. If the tens digit in the service status is “1”, the delivery service was already requested for the service-requested merchandise.

If the tens digit in the service status is “0”, that is, if the customer requests the delivery service, the processor 21 proceeds to ACT 27. The processor 21 controls the wireless unit 26 to transmit a delivery setting request command, as ACT 27. By this control, a delivery setting request command can be wirelessly transmitted via the wireless unit 26. The delivery setting request command is received at the access point 15 and transmitted to the mobile controller 14 via the communication network 16. The delivery setting request command includes the user ID and the merchandise code of the service-requested merchandise.

If the tens digit in the service status is “1” in ACT 26, that is, if the customer cancels the delivery service request, the processor 21 proceeds to ACT 28. The processor 21 controls the wireless unit 26 to transmit a delivery cancellation request command, as ACT 28. By this control, a delivery cancellation request command can be wirelessly transmitted via the wireless unit 26. The delivery cancellation request command is received at the access point 15 and transmitted to the mobile controller 14 via the communication network 16. The delivery cancellation request command includes the user ID and the merchandise code of the service-requested merchandise.

In the standby states of ACT 23 to ACT 25, if the packaging key is selected, the processor 21 proceeds from ACT 24 to ACT 29. As ACT 29, the processor 21 refers to the data of the transaction file 521 stored in the main memory 22, and checks whether or not the ones digit in the service status associated with the merchandise sales data of the service-requested merchandise is “1”. If the ones digit in the service status is “0”, the packaging service is not yet requested for the service-requested merchandise. If the ones digit in the service status is “1”, the packaging service was already requested for the service-requested merchandise.

If the ones digit in the service status is “0”, that is, if the customer requests the packaging service, the processor 21 proceeds to ACT 30. The processor 21 waits for a packaging method to be designated, as ACT 30. Specifically, as shown in FIG. 29, the processor 21 changes the soft keys displayed in the operation key area 122 of the service screen 120 to a “simple packaging key” and a “gift key”. The simple packaging key is selected if the customer wants to request simple packaging as the packaging method. The gift key is selected if the customer wants to request gift wrapping as the packaging method.

The processor 21 waits for the simple packaging key or gift key to be entered in ACT 30. After the simple packaging key or the gift key is pressed, the processor 21 controls the wireless unit 26 to transmit a packaging setting request command, as ACT 31. By this control, the packaging setting request command is wirelessly transmitted via the wireless unit 26. The packaging setting request command is received at the access point 15 and transmitted to the mobile controller 14 via the communication network 16. The packaging setting request command includes the user ID, the merchandise code of the service-requested merchandise, and the packaging method data. The packaging method data is data indicating simple packaging if the simple packaging key was selected in ACT 30. The packaging method data is data indicating gift wrapping if the gift key was selected in ACT 30.

If the ones digit in the service status is “1” in ACT 29, that is, if the customer cancels the packaging service request, the processor 21 proceeds to ACT 32. The processor 21 controls the wireless unit 26 to transmit a packaging cancellation request command, as ACT 32. By this control, the packaging cancellation request command is wirelessly transmitted via the wireless unit 26. The packaging cancellation request command is received at the access point 15 and transmitted to the mobile controller 14 via the communication network 16. The packaging cancellation request command includes the user ID and the merchandise code of the service-requested merchandise.

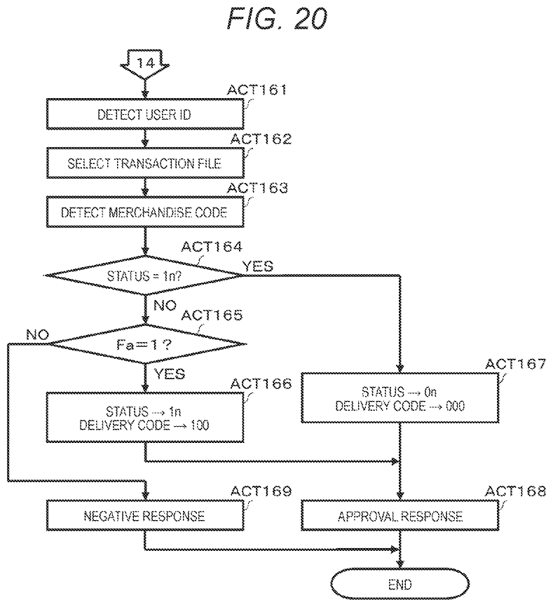

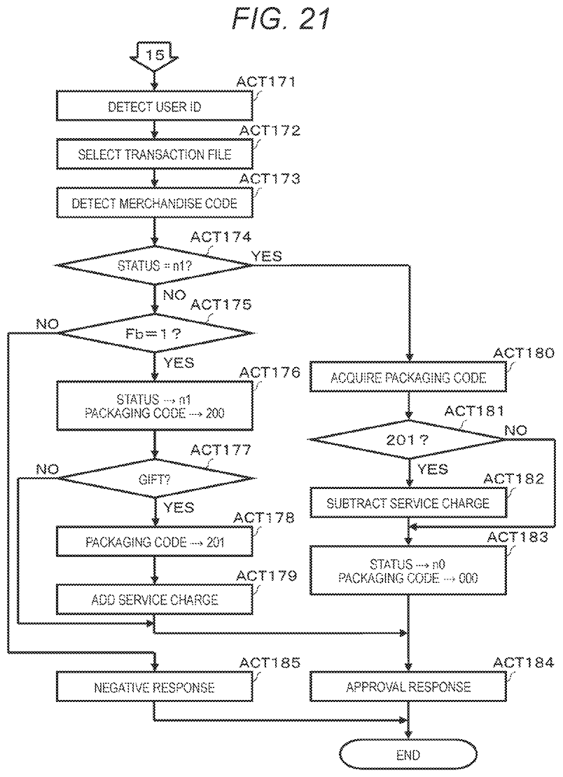

The processor 21 that transmitted the delivery setting request command, the delivery cancellation request command, the packaging setting request command, or the packaging cancellation request command waits for a response command, as ACT 33. As will be described later with reference to FIGS. 20 and 21, the mobile controller 14 returns an approval response command or a negative response command after receiving a delivery setting request command, a delivery cancellation request command, a packaging setting request command, or a packaging cancellation request command. If the merchandise for which the delivery service or packaging service is requested is the target merchandise for that service, the mobile controller 14 returns an approval response command. If the merchandise for which the delivery service or packaging service is requested is not the target merchandise for that service, the mobile controller 14 returns a negative response command.

The processor 21 that receives the approval response command in ACT 33 proceeds to ACT 35. As ACT 35, the processor 21 clears the service screen 120 and returns to ACT 16 of FIG. 13. The processor 21 updates the registration screen 110 based on the data of the transaction file 521 included in the approval response command. After that, the processor 21 enters a standby state for ACT 17 to ACT 19.

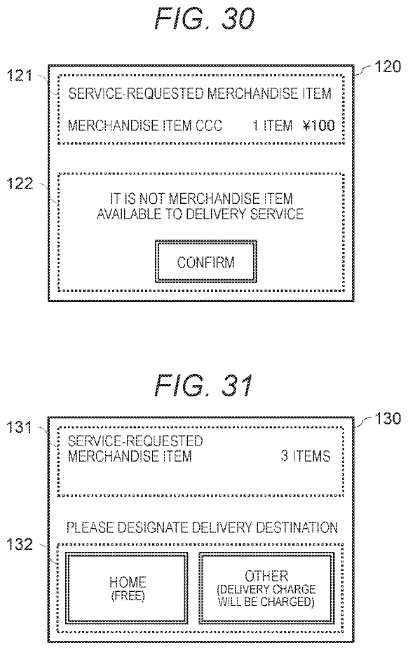

The processor 21 that receives the negative response command in ACT 33 proceeds to ACT 34. The processor 21 waits for the customer's confirmation input, as ACT 34. Specifically, as shown in FIG. 30, the processor 21 changes the soft keys displayed in the operation key area 122 of the service screen 120 to a confirmation key. Also, a message is displayed in the operation key area 122 to notify that the merchandise for which the delivery service or packaging service was requested is not the target merchandise of the service. After confirming this message, the customer presses a confirmation key. After the confirmation key is pressed, the processor 21 proceeds to ACT 35. As ACT 35, the processor 21 clears the service screen 120 and returns to ACT 16 of FIG. 13. The negative response command does not contain the data of the transaction file 521. Therefore, the processor 21 enters a standby state for ACT 17 to ACT 19 without updating the registration screen 110.

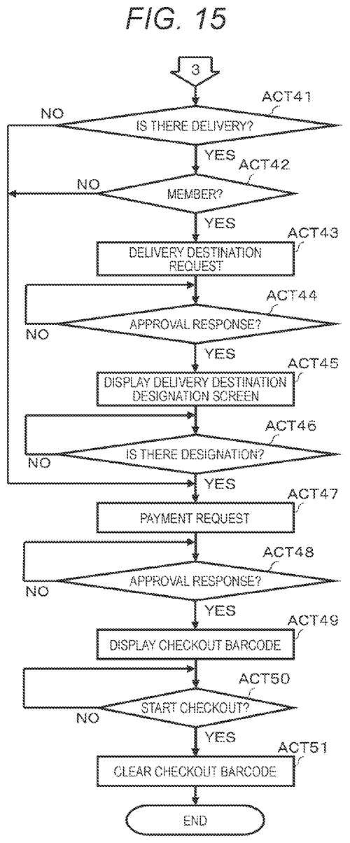

In the standby states of ACT 17 to ACT 19, if the payment key is pressed, the processor 21 proceeds from ACT 19 to ACT 41 in FIG. 15. The processor 21 checks whether or not there is merchandise for which the delivery service was requested among the merchandise registered, as ACT 41. If the status data associated with the merchandise sales data contained in the transaction file stored in the main memory 22 has a service status with the tens digit of “1”, the processor 21 recognizes that there is merchandise for which the delivery service was requested. If there is no service status with the tens digit of “1”, the processor 21 recognizes that there is no merchandise for which the delivery service was requested.

If there is merchandise for which the delivery service was requested, the processor 21 proceeds to ACT 42. As ACT 42, the processor 21 checks whether or not the user of the information terminal 2 is a member. If a member ID is stored in member ID area 233, the processor 21 recognizes that the user is a member. If no member ID is stored in member ID area 233, the processor 21 recognizes that the user is not a member.

If the user is a member, the processor 21 proceeds to ACT 43. The processor 21 controls the wireless unit 26 to transmit a delivery destination request command, as ACT 43. By this control, the delivery destination request command is wirelessly transmitted via the wireless unit 26. The delivery destination request command is received at the access point 15 and transmitted to the mobile controller 14 via the communication network 16. The delivery destination request command includes the user ID and the member ID.

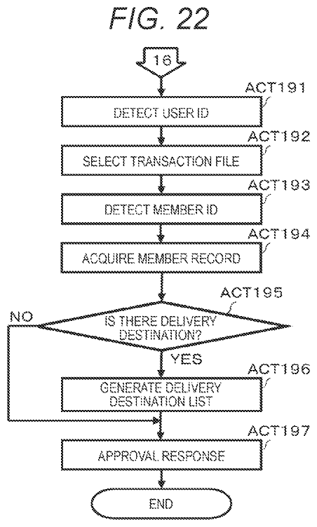

The processor 21 waits for an approval response command, as ACT 44, after sending the delivery destination request command. As will be described later with reference to FIG. 22, the mobile controller 14 returns an approval response command after receiving the delivery destination request command. The processor 21 then displays a delivery destination designation screen 130 (see FIG. 31) on the touch panel 24, as ACT 45.

FIG. 31 is a schematic diagram showing a display example of the delivery destination designation screen 130. The delivery destination designation screen 130 is composed of a quantity area 131 and an operation key area 132. The quantity area 131 displays the total quantity of the merchandise for which the delivery service was requested. In the operation key area 132, the home key and the other key are displayed as soft keys. A customer whose delivery destination is his/her home selects the home key. A customer whose delivery destination is other than his/her home selects the other key.

The processor 21 that displayed the delivery destination designation screen 130 waits for the delivery destination to be designated, as ACT 46. If the home key is selected, the processor 21 recognizes that the home is designated as the delivery destination. If the other key is selected, the processor 21 recognizes that a place other than home was designated as the delivery destination. Here, if at least one delivery address is registered in the member record 321 identified by the member ID of the customer, a list of delivery addresses, a so-called delivery destination list, is displayed on the touch panel 24. Then, the customer selects the desired delivery address from the delivery destination list. After an address is selected, the processor 21 recognizes the selected address is designated as the delivery destination. If the desired delivery destination in the delivery destination list, the customer selects NOT AVAILABLE. In the case of NOT AVAILABLE, the processor 21 recognizes that a place other than the home was designated as the delivery destination.

After the delivery destination is designated, the processor 21 proceeds to ACT 47. If there is no delivery request in ACT 41, the processor 41 skips the processing of ACT 42 to ACT 46 and proceeds to ACT 47. Also, if the user is not a member in ACT 42, the processor 21 skips the processing of ACT 43 to ACT 46 and proceeds to ACT 47.

Thus, if the delivery destination is designated by the processing of ACT 43 to ACT 46, or if the processing of ACT 43 to ACT 46 is skipped, the processor 21 proceeds to ACT 47. The processor 21 controls the wireless unit 26 to transmit a payment request command, as ACT 47. By this control, the payment request command is wirelessly transmitted via the wireless unit 26. The payment request command is received at the access point 15 and transmitted to the mobile controller 14 via the communication network 16. The payment request command contains the user ID. Further, if the delivery destination was designated, information indicating the delivery destination is also included in the payment request command. That is, if the home key is selected, the payment request command includes information indicating that the home address is the delivery destination. If the other key is selected, the payment request command includes information indicating that a place other than the home address is designated as the delivery destination.

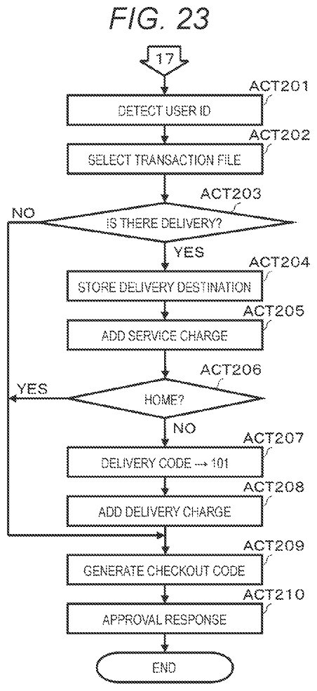

The processor 21 waits for an approval response command, as ACT 48, after transmitting the payment request. As will be described later with reference to FIG. 23, the mobile controller 14 that receives the payment request command returns an approval response command. The approval response command contains a checkout code. The checkout code is a unique code generated each time a payment request command is received. The processor 21 causes the touch panel 24 to display a checkout barcode representing the checkout code in the form of a barcode, as ACT 49, after receiving the approval response command.

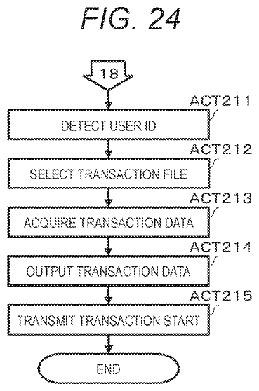

The processor 21 then waits for a checkout start command, as ACT 50. The checkout barcode is a barcode to be read by the scanner 77 of the settlement terminal 11. Settlement processing is started in the settlement terminal 11 after reading the checkout barcode with the scanner 77. At this time, as will be described later with reference to FIG. 24, the mobile controller 14 transmits a checkout start command to the information terminal 2 that sent the payment request command. The processor 21 then clears the checkout barcode on the touch panel 24, as ACT 51. Accordingly, the processor 21 ends the information processing of the procedures shown in the flowcharts of FIGS. 12 to 15.

<Description of Operation of Mobile Controller>

Next, certain operations of the mobile controller 14 will be described using the flowcharts of FIGS. 16 to 25. The processor 51 of the mobile controller 14 waits for a request command as ACT 101 in FIG. 16. Upon receiving a request command via the communication interface 55, the processor 51 identifies the type of the request command as ACT 102 to ACT 111 and executes information processing according to the type.

«Description of Operation if Check-In Request Command is Received»

If the request command is a check-in request command issued from the information terminal 2, the processor 51 proceeds from ACT 102 to ACT 121 in FIG. 17. The processor 51 detects the user ID from the check-in request command, as ACT 121. The processor 51 generates a transaction file 521 for the customer identified by the user ID, as ACT 122. This transaction file 521 stores the user ID detected in ACT 121.

The processor 51 checks whether or not a check-in request command was issued from the information terminal 2 linked with the member ID, as ACT 123. If the member ID is included in the check-in request command, the processor 51 recognizes that the check-in request command was issued from the information terminal 2 linked with the member ID. If the member ID is not included in the check-in request command, the processor 51 recognizes that the check-in request command is issued from the information terminal 2 that is not linked with the member ID.

If the check-in request command is issued from the information terminal 2 linked with the member ID, the processor 51 proceeds to ACT 124. The processor 51 stores the member ID included in the check-in request command in the transaction file 521 generated by the processing of ACT 122, as ACT 124. Also, the delivery declaration flag Fc of the transaction file 521 is set to default “0”.

If the check-in request command is issued from the information terminal 2 that is not linked with the member ID, the processor 51 skips the processing of ACT 124. If the processing of ACT 124 is completed or skipped, the processor 51 proceeds to ACT 125. As ACT 125, the processor 51 transmits an approval response command to the information terminal 2 that sent the check-in request command. Accordingly, the processor 51 ends the information processing of the procedure shown by the flowchart of FIG. 17.

On the information terminal 2 that receives the approval response command, the start screen 100 is displayed on the touch panel 24 in ACT 6 of FIG. 12, as described above.

«Description of Operation if Delivery Declaration Request Command is Received»

If the request command is a delivery declaration request command issued from the information terminal 2, the processor 51 proceeds from ACT 103 to ACT 131 in FIG. 18. The processor 51 detects the user ID from the delivery declaration request command, as ACT 131. The processor 51 then selects the transaction file 521 in which that user ID is stored, as ACT 132. The transaction file 521 in which the user ID acquired from the command is stored is hereinafter referred to as the target transaction file 521.

The processor 51 checks the delivery declaration flag Fc stored in the target transaction file 521, as ACT 133. If the delivery declaration flag Fc is “0”, the processor 51 proceeds to ACT 134. The processor 51 changes the delivery declaration flag Fc to “1” as ACT 134. If the delivery declaration flag Fc is “1”, the processor 51 proceeds to ACT 135. The processor 51 changes the delivery declaration flag Fc to “0” as ACT 135.

After completing the processing of ACT 134 or ACT 135, the processor 51 proceeds to ACT 136. As ACT 136, the processor 51 transmits an approval response command to the information terminal 2 that sent the delivery declaration request command. Accordingly, the processor 51 ends the information processing of the procedure shown by the flowchart of FIG. 18.

On the information terminal 2 that receives the approval response command, the registration screen 110 is displayed on the touch panel 24 in ACT 11 of FIG. 12, as described above.

«Description of Operation if Merchandise Registration Request Command is Received»

If the request command is a merchandise registration request command issued from the information terminal 2, the processor 51 proceeds from ACT 104 to ACT 141 in FIG. 19. The processor 51 detects the user ID from the merchandise registration request command as ACT 141. The processor 51 then selects the transaction file 521 that stored the user ID, that is, the target transaction file 521, as ACT 142.

The processor 51 detects the merchandise code from the merchandise registration request command, as ACT 143. Then, the processor 51 accesses the store server 13 and acquires the merchandise data described in the merchandise record 311 including the merchandise code from the merchandise database 31, as ACT 144. Based on the merchandise data, the processor 51 stores the merchandise sales data including the merchandise code, the merchandise name, the price, the sales quantity, the sales amount of money, the delivery target flag Fa, the packaging target flag Fb, and the like in the target transaction file 521, as ACT 145. At this time, the processor 51 also updates the total data in the target transaction file 521.

The processor 51 checks the delivery declaration flag Fc stored in the target transaction file 521, as ACT 146. If the delivery declaration flag Fc is “1”, that is, if the delivery request is designated for all items, the processor 51 proceeds to ACT 147. As ACT 147, the processor 51 checks the delivery target flag Fa of the merchandise data acquired in ACT 144. If the delivery target flag Fa is “1”, that is, if the merchandise for delivery service is registered, the processor 51 proceeds to ACT 148. As ACT 148, the processor 51 sets the service status of the service data stored in association with the merchandise sales data stored in the transaction file 521 in ACT 145 to “10”. The processor 51 also sets the delivery code of the service data to “100” and the packaging code to “000”.

On the other hand, if the delivery declaration flag Fc is “0” in ACT 146, that is, the delivery request is not designated for all items, or if the delivery target flag Fa is “0” in ACT 147, that is, the delivery request is designated for all items but merchandise that is not the target merchandise for the delivery service is registered, the processor 51 proceeds to ACT 149. As ACT 149, the processor 51 sets the service status of the service data stored in association with the merchandise sales data stored in the transaction file 521 in ACT 145 to “00”. Also, the processor 51 sets both the delivery code and the packaging code of the same service data to “000”.

After completing the processing of ACT 148 or ACT 149, the processor 51 proceeds to ACT 150. As ACT 150, the processor 51 transmits an approval response command to the information terminal 2 that sent the merchandise registration request command. The approval response command includes data of the target transaction file 521. Accordingly, the processor 51 ends the information processing of the procedure shown by the flowchart of FIG. 19.

On the information terminal 2 that receives the approval response command, the data in the detail area 111 and the total area 112 of the registration screen 110 are updated in ACT 16 of FIG. 13, as described above. At this time, if the delivery code of the service data is “100”, that is, if the merchandise for delivery service is registered in the state of a delivery request for all items being designated, the delivery service mark 115 lights up in the detail line of the merchandise.

«Description of Operation if Delivery Setting Request Command or Delivery Deletion Request Command is Received»

If the request command is a delivery setting request command issued from the information terminal 2, the processor 51 proceeds from ACT 105 to ACT 161 in FIG. 20. Similarly, if the request command is a delivery deletion request command issued from the information terminal 2, the processor 51 proceeds from ACT 106 to ACT 161 in FIG. 20. The processor 51 detects the user ID from the delivery setting request command or the delivery deletion request command, as ACT 161. The processor 51 then selects the transaction file 521 that stored the user ID, that is, the target transaction file 521, as ACT 162.

The processor 51 detects the merchandise code from the delivery setting request command or the delivery deletion request command, as ACT 163. The processor 51 checks the service status of the service data stored in the target transaction file 521 associated with the merchandise sales data containing that merchandise code, as ACT 164.

If the tens digit in the service status is “0”, that is, the delivery setting request command is received, the processor 51 proceeds from ACT 164 to ACT 165. As ACT 165, the processor 51 checks the delivery target flag Fa of the merchandise sales data including the merchandise code. If the delivery target flag Fa is “1”, the processor 51 proceeds to ACT 166. As ACT 166, the processor 51 sets the tens digit in the service status to “1”. The processor 51 also sets the delivery code of the service data to “100”.

In ACT 164, if the tens digit in the service status is “1”, that is, a delivery cancellation request command is received, the processor 51 proceeds to ACT 167. As ACT 167, the processor 51 sets the tens digit in the service status to “0”. The processor 51 also sets the delivery code of the service data to “000”.

After completing the processing of ACT 166 or ACT 167, the processor 51 proceeds to ACT 168. As ACT 168, the processor 51 transmits an approval response command to the information terminal 2 that sent the delivery setting request command or the delivery deletion request command. Accordingly, the processor 51 ends the information processing of the procedure shown by the flowchart of FIG. 20.

If the delivery target flag Fa is “0” in ACT 165, the processor 51 proceeds to ACT 169. As ACT 169, the processor 51 transmits a negative response command to the information terminal 2 that sent the delivery setting request command or the delivery deletion request command. Accordingly, the processor 51 ends the information processing of the procedure shown by the flowchart of FIG. 20.

On the information terminal 2 that receives the approval response command, the service screen 120 is cleared in ACT 35 of FIG. 14, as described above. Then, in ACT 16 of FIG. 13, the data in the detail area 111 and the total area 112 of the registration screen 110 are updated based on the data in the transaction file 521. At this time, the delivery service mark 115 lights up in the detail line of the registered merchandise for which the delivery code of the service data is “100”, that is, the merchandise for which the customer requested the delivery service by entering the delivery key on the service screen 120. Conversely, the delivery service mark 115 is turned off in the detail line of the registered merchandise for which the delivery code of the service data is “000”, that is, the merchandise for which the customer canceled the delivery service by entering the service key 114 of the merchandise for which the customer already requested the delivery service on the registration screen 110.

On the information terminal 2 that receives the negative response command, as described above, a message is displayed on the touch panel 24 to notify that the merchandise for which the delivery service was requested is not the target merchandise for that service. After a confirmation operation is performed on this message, the service screen 120 is cleared and the screen of the touch panel 24 returns to the registration screen 110 before the service key is pressed.

«Description of Operation if Packaging Setting Request Command or Packaging Deletion Request Command is Received»

If the request command is a packaging setting request command issued from the information terminal 2, the processor 51 proceeds from ACT 107 to ACT 171 in FIG. 21. Similarly, if the request command is a packaging deletion request command issued from the information terminal 2, the processor 51 proceeds from ACT 108 to ACT 171 of FIG. 21. The processor 51 detects the user ID from the packaging setting request command or the packaging deletion request command, as ACT 171. The processor 51 then selects the transaction file 521 that stored the user ID, that is, the target transaction file 521, as ACT 172.

The processor 51 detects the merchandise code from the packaging setting request command or the packaging deletion request command, as ACT 173. The processor 51 checks the service status of the service data stored in the target transaction file 521 associated with the merchandise sales data containing that merchandise code, as ACT 174.

If the ones digit in the service status is “0”, that is, if the packaging setting request command is received, the processor 51 proceeds to ACT 175. The processor 51 checks the packaging target flag Fb of the merchandise sales data including the merchandise code, as ACT 175. If the packaging target flag Fb is “1”, the processor 51 proceeds to ACT 176. As ACT 176, the processor 51 sets the ones digit in the service status to “1”. The processor 51 also sets the packaging code of the service data to “200”.

The processor 51 checks the packaging method data included in the packaging setting request command, as ACT 177. If the packaging method data is data indicating gift wrapping, the processor 51 changes the packaging code of the service data from “200” to “201”, as ACT 178. The processor 51 also adds the service charge set in the service record 3314 of the packaging code “201”, that is, the box charge, to the service charge and the price of the total data of the target transaction file 521, respectively, as ACT 179.

In ACT 177, if the packaging method data indicates simple packaging, the processor 51 skips the processing of ACT 178 and ACT 179. If the processing of ACT 178 and ACT 179 is completed or skipped, the processor 51 proceeds to ACT 184. The processing of ACT 184 will be described later.

In ACT 174, if the ones digit in the service status is “1”, that is, if a packaging cancellation request command is received, the processor 51 proceeds to ACT 180. The processor 51 acquires the packaging code of the service data, as ACT 180. The processor 51 checks whether or not the packaging code is “201” as ACT 181. If the packaging code is “201”, the processor 51 subtracts the service charge set in the service record 3314 of the packaging code “201”, that is, the box charge, from the service charge of the target transaction file 521 and the price of the total data, respectively, as ACT 182. If the packaging code is not “201”, the processor 51 skips the processing of ACT 182. If the processing of ACT 182 is completed or skipped, the processor 51 proceeds to ACT 183. As ACT 183, the processor 51 sets the ones digit in the service status to “0”. The processor 51 also sets the packaging code of the service data to “000”. The processor 51 then proceeds to ACT 184.

As ACT 184, the processor 51 transmits an approval response command to the information terminal 2 that sent the packaging setting request command or the packaging deletion request command. Accordingly, the processor 51 ends the information processing of the procedure shown by the flowchart of FIG. 21.

If the packaging target flag Fb is “0” in ACT 175, the processor 51 proceeds to ACT 185. As ACT 185, the processor 51 transmits a negative response command to the information terminal 2 that sent the packaging setting request command or the packaging deletion request command. Accordingly, the processor 51 ends the information processing of the procedure shown by the flowchart of FIG. 21.

On the information terminal 2 that receives the approval response command, the service screen 120 is cleared in ACT 35 of FIG. 14, as described above. Then, in ACT 16 of FIG. 13, the data in the detail area 111 and the total area 112 of the registration screen 110 are updated based on the data in the transaction file 521. At this time, a packaging service mark 116 lights up in the detail line of the registered merchandise for which the delivery code of the service data is “200” or “201”, that is, the merchandise for which the customer requested the packaging service by entering the packaging key on the service screen 120. Conversely, the packaging service mark 116 is turned off in the detail line of the registered merchandise for which the packaging code of the service data is “000”, that is, the merchandise for which the customer canceled the packaging service by entering the service key 114 of the merchandise for which the customer already requested the packaging service on the registration screen 110.

On the information terminal 2 that receives the negative response command, as described above, a message is displayed on the touch panel 24 to notify that the merchandise designated for the packaging service is not the target merchandise for that service. If a confirmation operation is performed on this message, the service screen 120 is cleared and the screen of the touch panel 24 returns to the registration screen 110 before the service key was pressed.

«Description of Operation if Delivery Destination Request Command is Received»

If the request command is a delivery destination request command issued from the information terminal 2, the processor 51 proceeds from ACT 109 to ACT 191 in FIG. 22. The processor 51 detects the user ID from the delivery destination request command, as ACT 191. The processor 51 then selects the transaction file 521 that stored the user ID, that is, the target transaction file 521, as ACT 192.

The processor 51 detects the member ID from the delivery destination request command, as ACT 193. Then, the processor 51 accesses the store server 13 and acquires the member record 321 of the member identified by the member code from the member database 32, as ACT 194.

As ACT 195, the processor 51 checks whether or not one or more delivery addresses are set in the member record 321. If a delivery address is set, the processor 51 generates a delivery destination list in which the one or more delivery addresses are listed as ACT 196. If the delivery address is not set, the processor 51 skips the processing of ACT 196.

If the processing of ACT 196 is completed or skipped, the processor 51 proceeds to ACT 197. As ACT 197, the processor 51 transmits an approval response command to the information terminal 2 that sent the delivery destination request command. The approval response command includes the home address as delivery destination data. Also, if a delivery destination list is generated, this delivery destination list is also included as delivery destination data. Accordingly, the processor 51 ends the information processing of the procedure shown by the flowchart of FIG. 21.

On the information terminal 2 that receives the approval response command, the delivery destination designation screen 130 is displayed on the touch panel 24 in ACT 45 of FIG. 15, as described above. If the delivery destination data includes a delivery destination list, if the other key on the delivery destination designation screen 130 is selected, the delivery destination list is displayed.

«Description of Operation if Payment Request Command is Received»

If the request command is a payment request command issued from the information terminal 2, the processor 51 proceeds from ACT 110 to ACT 201 in FIG. 23. The processor 51 detects the user ID from the payment request command as ACT 201. The processor 51 then selects the transaction file 521 that stored the user ID, that is, the target transaction file 521, as ACT 202.

As ACT 203, the processor 51 checks whether or not the delivery service was requested. If the payment request command includes information indicating the delivery destination, the processor 51 recognizes that there is a request for delivery service. If the payment request command does not contain the information indicating the delivery destination, the processor 51 recognizes that there is no delivery service request.

If there is a request for delivery service, the processor 51 proceeds to ACT 204. The processor 51 stores information indicating the delivery destination in target transaction file 521, as ACT 204. The processor 51 also adds the service charge set in the service record 3311 of the delivery code “100” to the service charge and the price of total data of the target transaction file 521, as ACT 205.

As ACT 206, the processor 51 checks whether or not the delivery destination is the home. If the information indicating the delivery destination indicates a place other than the home, the processor 51 proceeds to ACT 207. The processor 51 changes the delivery code of the service data with the delivery code of “100” among the service data stored in association with the merchandise sales data in the target transaction file 521 to “101”, as ACT 207. The processor 51 also adds the service charge set in the service record 3312 of the delivery code “101”, that is, the delivery charge, to the service charge and the price of the total data of the target transaction file 521, respectively, as ACT 208.

If the information indicating the delivery destination in ACT 206 indicates home, the processor 51 skips the processing of ACT 207 and ACT 208. If the processing of ACT 207 and ACT 208 is completed or skipped, the processor 51 proceeds to ACT 209. The processor 51 generates a checkout code, as ACT 209. The checkout code is data for coding the user ID detected in the processing of ACT 201 to a barcode. As ACT 210, the processor 51 transmits an approval response command to the information terminal 2 that sent the payment request command. The approval response command contains the checkout code.

On the other hand, if there is no delivery service request in ACT 203, the processor 51 proceeds to ACT 209. The processor 51 generates a checkout code, as ACT 209, and transmits an approval response command to the information terminal 2 that sent the payment request command, as ACT 210. Accordingly, the processor 51 ends the information processing of the procedure shown by the flowchart of FIG. 23.

On the information terminal 2 that receives the approval response command, as described above, the checkout barcode representing the checkout code in the form of a barcode is displayed on the touch panel 24 in ACT 49 of FIG. 15. After confirming the checkout barcode, the customer moves to the checkout place. Then, the customer scans the checkout barcode with the scanner 47 of the vacant settlement terminal 11.

«Description of Operation if Transaction Data Request Command is Received»

After the barcode of the checkout code displayed on the touch panel 24 of the information terminal 2 is scanned by the scanner 47 of the settlement terminal 11, the settlement terminal 11 transmits a transaction data request command to the mobile controller 14. The transaction data request command contains the user ID obtained from the checkout code.

If the request command is a transaction data request command, the processor 51 proceeds from ACT 111 to ACT 211 in FIG. 24. The processor 51 detects the user ID from the transaction data request command, as ACT 211. The processor 51 then selects the transaction file 521 that stored the user ID, that is, the target transaction file 521, as ACT 212.

The processor 51 acquires transaction data from the target transaction file 521, as ACT 213. The transaction data includes merchandise sales data and related service data, as well as service charge and total data. Further, if information indicating the delivery destination is stored in the target transaction file 521, the information is also included in the transaction data. The processor 51 outputs the transaction data to the settlement terminal 11, as ACT 214. Also, as ACT 215, the processor 51 transmits a checkout start command with the user ID detected in the processing of ACT 211 as the transmission destination. Accordingly, the processor 51 ends the information processing of the procedure shown by the flowchart of FIG. 24.

The checkout start command is received by the information terminal 2 with the destination user ID in the user ID area 232. On the information terminal 2, the barcode of the checkout code displayed on the touch panel 24 is cleared in ACT 51 of FIG. 15.

If the processor 51 receives a command other than an above-described request command, the processing according to this other command type is executed as ACT 112.

<Description of Function of Mobile Controller>

The processor 51 of the mobile controller 14 functions as the registration unit 511 by executing the processing of ACT 141 to ACT 145 in FIG. 19 in response to the merchandise registration request command from the information terminal 2.

The processor 51 implements the function of the reception unit 512 by executing the processing of ACT 161 to ACT 165 in FIG. 20 in response to the delivery setting request command from the information terminal 2. Also, the processor 51 implements the function as the reception unit 512 by executing the processing of ACT 171 to ACT 175 in FIG. 21 in response to the packaging setting request command from the information terminal 2.

The processor 51 implements the function as the association unit 513 by executing the processing of ACT 166 in FIG. 20. Also, the processor 51 implements the function as the association unit 513 by executing the processing of ACT 179 in FIG. 21.

The processor 51 implements the function as the output unit 514 by executing the processing of ACT 211 to ACT 214 in FIG. 24 in response to the transaction data request command from the settlement terminal 11.

The processor 51 implements the function as the totalization unit 515 by executing the processing of ACT 179 in FIG. 21 and the processing of ACT 205 and ACT 208 in FIG. 23.

The processor 51 implements the function as the delivery destination determination unit 516 by executing the processing of ACT 204 in FIG. 23 in response to the payment request command from the information terminal 2.

The processor 51 implements the function as the packaging method determination unit 517 by executing the processing of ACT 176 to ACT 178 in FIG. 21 in response to the packaging setting request command from the information terminal 2.

<Description of Operation of Settlement Terminal>

FIG. 25 is a flowchart showing the procedure of processing executed by the processor 41 of the settlement terminal 11. A guidance screen is displayed on the touch panel 46 of the settlement terminal 11 in the default state. The guidance screen is a screen that guides the customer to scan the barcode of the checkout code (displayed on the touch panel 46 of the information terminal 2) with the scanner 47. The processor 41 waits for the barcode of the checkout code to be scanned by the scanner 47 as ACT 301.

The customer then scans the barcode with the scanner 47 of the settlement terminal 11. When the barcode of the checkout code is scanned by the scanner 47, the processor 41 detects the user ID from the scanned barcode as ACT 302. The processor 41 transmits a transaction data request command to the mobile controller 14, as ACT 303. The transaction data request command is transmitted to the mobile controller 14 via the communication network 16. The transaction data request command includes the user ID detected in the processing of ACT 302.

The processor 71 waits for the transaction data as ACT 304 after sending transaction data request command. The mobile controller 14 retrieves transaction data from the transaction file matching the user ID included in the transaction data request command, as described with reference to FIG. 24. Then, the mobile controller 14 transmits the transaction data to the settlement terminal 11.

The processor 41 receives and stores the transaction data in the transaction memory, as ACT 305. Transaction memory is part of the volatile memory area of the main memory 42. The processor 41 acquires the top merchandise sales data from the transaction memory, as ACT 306. The processor 41 then examines the service status of the service data associated with the merchandise sales data, as ACT 307. If the tens digit in the service status is “1”, that is, if the delivery service was designated for the merchandise in the merchandise sales data associated with the service data, the processor 41 proceeds to ACT 308. The processor 41 stores the merchandise sales data in the delivery memory, as ACT 308. The delivery memory is part of the volatile memory area of the main memory 42. If the tens digit in the service status is “0”, the processor 41 skips the processing of ACT 308.

If the processing of ACT 308 is completed or skipped, the processor 41 checks whether or not the ones digit in the service status of the service data is “1”, as ACT 309. If the ones digit in the service status is “1”, that is, if the packaging service was designated for the merchandise in the merchandise sales data associated with the service data, the processor 41 proceeds to ACT 310. The processor 41 stores the merchandise sales data in the packaging memory, as ACT 310. The packaging memory is part of the volatile memory area of the main memory 42. If the ones digit in the service status is “0”, the processor 41 skips the processing of ACT 310.

If the processing of ACT 310 is completed or skipped, the processor 41 checks whether or not the processing of ACT 307 to ACT 310 described above was executed for all the merchandise sales data included in the transaction data, as ACT 311. If there is merchandise sales data for which the processing of ACT 307 to ACT 310 was not performed, the processor 41 returns to ACT 306. Then, the processor 41 acquires the next merchandise sales data from the transaction data and executes the processing of ACT 307 to ACT 310.

If the processing of ACT 307 to ACT 310 was completed for all the merchandise sales data included in the transaction data, the processor 41 proceeds to ACT 312. The processor 41 executes settlement processing for the total price included in the transaction data, as ACT 312. The settlement processing may be any one of the above-described cash settlement processing, credit settlement processing, electronic money settlement processing, or code settlement processing. Also, other settlement processing may be used.

If the settlement processing is completed, the processor 41 controls the dispensing of the transaction receipt 201 (see FIG. 32), as ACT 313. That is, the processor 41 generates print data for the transaction receipt 201 based on the transaction data stored in the transaction memory and outputs this print data to the printer 48.

Next, the processor 41 checks whether or not merchandise sales data is stored in the delivery memory, as ACT 314. If the delivery memory stores merchandise sales data, the processor 41 proceeds to ACT 315. The processor 41 controls the dispensing of the delivery receipt 202 (see FIG. 32), as ACT 315. That is, the processor 41 generates print data for the delivery receipt 202 based on the merchandise sales data stored in the delivery memory, and outputs this print data to the printer 48. If no merchandise sales data is stored in the delivery memory, the processor 41 skips the processing of ACT 315.

If the processing of ACT 315 is completed or skipped, the processor 41 checks whether or not merchandise sales data is stored in the packaging memory, as ACT 316. If the packaging memory stores merchandise sales data, the processor 41 proceeds to ACT 317. The processor 41 controls the dispensing of the packaging receipt 203 (see FIG. 32) as ACT 317. That is, the processor 41 generates print data for the packaging receipt 203 based on the merchandise sales data stored in the packaging memory, and outputs this print data to the printer 48. If no merchandise sales data is stored in the packaging memory, the processor 41 skips the processing of ACT 317.

If the processing of ACT 317 is completed or skipped, the processor 41 ends the information processing of the procedure shown in the flowchart of FIG. 25.

FIG. 32 is a schematic diagram showing a print example of the transaction receipt 201, the delivery receipt 202, and the packaging receipt 203. On the delivery receipt 202, the merchandise name and quantity of the merchandise for which the delivery service is requested are printed. The delivery address is also printed on the delivery receipt 202. On the packaging receipt 203, the merchandise name and the quantity of the merchandise for which the packaging service is requested are printed. The packaging method is also printed on the packaging receipt 203. On the transaction receipt 201, “delivery requested” is printed for the merchandise for which a delivery service is requested. Similarly, “packaging requested” is printed for the merchandise for which a packaging service is requested. The total price is printed separately for the subtotal, which is the total price of the registered merchandise, and the service charge.

As described above, the settlement terminal 11 that dispenses the delivery receipt 202 and the packaging receipt 203 functions as a visualization unit that displays the merchandise associated with services based on data output from the mobile controller 14, which is an example of a merchandise registration device.

Effects of Merchandise Registration System

The registration screen 110 is displayed on the touch panel 24 of the information terminal 2 that is used by the customer to register the merchandise to be purchased by himself/herself at the sales floor. The service key 114 is displayed on the registration screen 110 for each registered merchandise.

If the customer wishes to request a delivery service for an item among the registered merchandise, the customer enters the service key 114 corresponding to the service-requested merchandise item. Then, the screen of the touch panel 24 transitions to the service screen 120, and the customer enters the delivery key on the service screen 120. If the above operation is performed, the tens digit in the service status of the service data associated with the merchandise sales data of the service-requested merchandise stored in the transaction file 521 becomes “1”. Also, the delivery code of the same service data becomes “100”.

If the customer who has finished shopping on the sales floor selects the payment key on the registration screen 110, the touch panel 24 displays the delivery destination designation screen 130. Here, if the home is the delivery destination, the customer selects the home key. If the delivery destination is a place other than the home, the customer selects the other key. If the other key is selected, the delivery destination list of addresses previously designated as the delivery destination by the customer can be displayed, and the customer selects a desired delivery destination from the delivery destination list. After the above operations are performed, the checkout barcode is displayed on the touch panel 24, and thus, the customer scans the checkout barcode with the scanner 47 of the vacant settlement terminal 11, and then performs the operation for the payment of the price on the settlement terminal 11. The price includes the service charge for the delivery service. In addition, the delivery charge is included if the merchandise is to be delivered to a place other than the home. After the above operations are performed, the transaction receipt 201 and the delivery receipt 202 are dispensed from the settlement terminal 11. On the delivery receipt 202, information about the merchandise for which the customer requested the delivery service and information indicating the delivery destination are printed.

Then, the customer goes to the service counter and presents the delivery receipt 202 to the store clerk together with the items of merchandise requested to be delivered. The store clerk performs procedures associates with delivering the merchandise to the delivery destination printed on the delivery receipt 202. At this time, since the delivery receipt 202 is available, the store clerk does not need to keep track of the delivery information by writing the delivery information in a ledger or inputting the delivery information into a dedicated terminal, and only needs to receive the merchandise presented by the customer and the delivery receipt 202. Also, there is no need to collect service charges or delivery charges from customers since the service charges or delivery charges were already paid. This simplifies effort required by the store clerk to respond to customers and shortens the response time, thereby improving the efficiency of the delivery service reception work at the service counter.

On the delivery receipt 202, the information of the merchandise for which the customer requested the delivery service is printed. Therefore, an operation in which the store clerk prepares the merchandise items to be delivered according to the delivery receipt 202 can be implemented. By doing so, the customer using the delivery service does not necessarily have to carry the merchandise items from the sales floor to the service counter. In general, the delivery service can be used as a service for reducing the burden of bringing home merchandise for the elderly. Therefore, by adopting the above operation, elderly people also do not have to carry the merchandise to the service counter, so the number of users of the delivery service may increase, and an increase in store revenues can be expected.

A customer who desires to request a packaging service for a merchandise item among the registered merchandise also selects the service key 114 corresponding to the service-requested merchandise item. Then, the screen of the touch panel 24 transitions to the service screen 120, and the customer presses the packaging key on the service screen 120. A customer who desires simple packaging presses a simple packaging key, and a customer who desires gift wrapping presses a gift key. After the above operation is performed, the ones digit (place) in the service status of the service data associated with the merchandise sales data of the service-requested merchandise stored in the transaction file 521 becomes “1”. Also, the delivery code of the same service data becomes “200” or “201”.

After the customer who finished shopping on the sales floor selects the payment key on the registration screen 110, the checkout barcode is displayed on the touch panel 24, and the customer scans the checkout barcode with the scanner 47 of the vacant settlement terminal 11, and then, performs an operation for the payment of the price to the settlement terminal 11. The price includes the box charge if gift wrapping is selected as the packaging method. After the above operations are performed, the transaction receipt 201 and the packaging receipt 203 are dispensed from the settlement terminal 11. On the packaging receipt 203, information about the merchandise for which the customer requested the packaging service and information indicating the packaging method are printed.

Then, the customer goes to the service counter and presents the packaging receipt 203 to the store clerk together with the merchandise requested to be packaged. The store clerk packages the merchandise according to the packaging method printed on the packaging receipt 203 and returns the packaged merchandise to the customer. At this time, since the packaging receipt 203 is available, the store clerk does not need to keep track of the packaging information by writing the packaging information in a ledger or inputting the packaging information into a dedicated terminal, but only needs to receive the packaging receipt 203. Also, since the box charge was already paid, there is no need to collect the box charge from the customer. This simplifies the effort required for the store clerk to respond to customers and shortens the response time, thereby improving the efficiency of the packaging service reception work at the service counter.

By the way, on the transaction receipt 201 received by the customer, “delivery requested” is printed for the merchandise item for which the delivery service is requested, and “packaging requested” is printed for the merchandise item for which the packaging service is requested. A service charge is also printed separately from the subtotal, which is the price of the registered merchandise. Therefore, the customer can easily specify the merchandise for which the delivery service is requested or the merchandise for which the packaging service is requested from the transaction receipt 201. The customer can also know the charges for the service from the transaction receipt 201.

Also, on the registration screen 110, the delivery service mark 115 lights up for the merchandise for which the delivery service is requested, and the packaging service mark 116 lights up for the merchandise for which the packaging service is requested. Therefore, the customer can easily specify the merchandise for which the delivery service is requested or the merchandise for which the packaging service is requested from the information on the registration screen 110.

Here, for example, if the customer desires to cancel the request for the delivery service, the customer enters the service key 114 corresponding to the merchandise. Similarly, if the customer desires to cancel the request for the packaging service, the customer enters the service key 114 corresponding to the merchandise. By the above operation, the tens or ones digit in the service status of the service data associated with the merchandise becomes “0”. Also, the delivery code or packaging code of the same service data becomes “000”. In this manner, the customer can easily cancel the requested service simply by entering the service key 114.

In addition, a delivery request key is provided on the start screen 100 displayed on the touch panel 24 of the information terminal 2 before the customer starts shopping. A customer who desires to request a delivery service for all of the merchandise items to be purchased selects the delivery request key. Then, among the merchandise for which the customer registered, the tens digit in the service status of the service data becomes “1” and the delivery code becomes “100” for the merchandise for which the delivery service is provided. Therefore, the customer does not need to input the service key 114 one by one to select the merchandise items for which the delivery service is requested on the registration screen 110. This effect is very convenient for the elderly who wishes to use the delivery service for all items, and an increase in the number of users of the delivery service can be expected.

### Second Embodiment

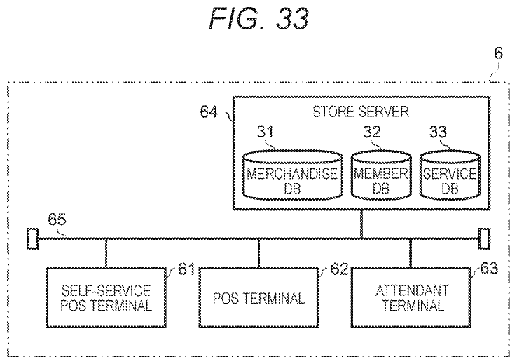

A second embodiment exemplifies a merchandise registration system 6 in FIG. 33 that can improve the efficiency of operations at the service counter. This merchandise registration system 6 is a system built in a store in which customers use self-service POS terminals 61 to register merchandise to be purchased by himself/herself. As for the services available to the customer at the service counter, the delivery service and the packaging service are provided as examples as in the first embodiment.

Description of Merchandise Registration System

FIG. 33 is a block diagram showing a schematic configuration of the merchandise registration system 6. The merchandise registration system 6 includes a self-service POS terminal 61, a POS terminal 62, an attendant terminal 63, and a store server 64. The merchandise registration system 6 includes a communication network 65 such as a LAN, and the self-service POS terminal 61, the POS terminal 62, the attendant terminal 63, and the store server 64 are connected to the communication network 65 to constitute the merchandise registration system 6. The communication network 65 may be wired or wireless. Also, the communication network 65 may use both wired and wireless.

The self-service POS terminal 61 is a device for a customer to perform merchandise registration operations and price payment operations by himself/herself. The POS terminal 62 is a device for a store clerk to perform merchandise registration operations and price payment operations. The self-service POS terminal 61 and the POS terminal 62 are installed in a checkout place provided separately from the sales floor where the items of merchandise are displayed. The number of installed self-service POS terminals 61 and POS terminals 62 is not particularly limited. The self-service POS terminal 61 is an example of a merchandise registration device.

The attendant terminal 63 is a device having a function of displaying the monitoring image of the self-service POS terminal 61 on a display device. The attendant terminal 63 is installed near the exit of the checkout place. At the place where the attendant terminal 63 is installed, a store clerk called an attendant is stationed. The monitoring image transitions according to the operation input to the self-service POS terminal 61. The attendant monitors erroneous operation, unauthorized operation, or the like of the customer from the information of the monitoring image.

The store server 64 is a computer that supports overall store operations. For that support, the store server 64 manages various databases such as the merchandise database 31, the member database 32, the service database 33, and the like. The merchandise database 31, the member database 32, and the service database 33 are the same as those in the first embodiment, so additional descriptions thereof will be omitted here.

Description of Configuration of Self-service POS Terminal

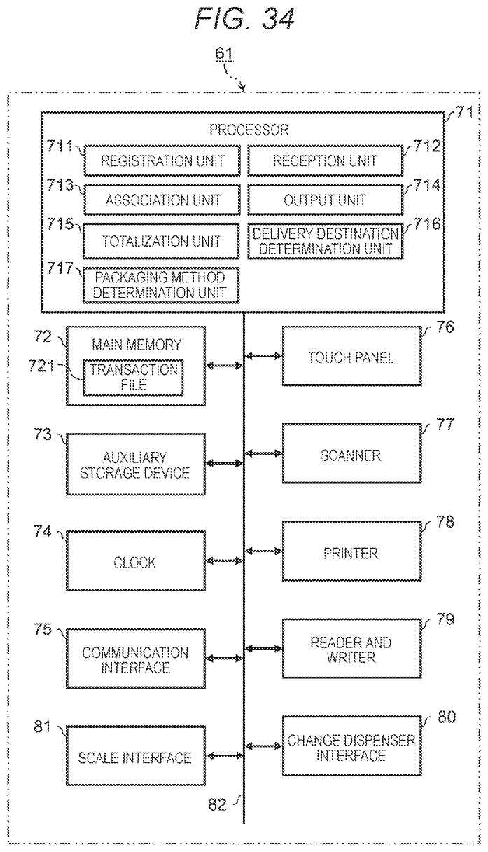

FIG. 34 is a block diagram showing a configuration of the self-service POS terminal 61. The self-service POS terminal 61 includes a processor 71, a main memory 72, an auxiliary storage device 73, a clock 74, a communication interface 75, a touch panel 76, a scanner 77, a printer 78, a reader and writer 79, a change dispenser interface 80, a scale interface 81, a system transmission line 82, and the like. The system transmission line 82 includes an address bus, a data bus, control signal lines, and the like. The system transmission line 82 connects the processor 71 and other units directly or via a signal input and output circuit, and transmits data signals exchanged therebetween.

The self-service POS terminal 61 connects the processor 71, the main memory 72, the auxiliary storage device 73, the clock 74, and the communication interface 75 via the system transmission line 82. The self-service POS terminal 61 connects to device interfaces or otherwise incorporates devices such as the touch panel 76, the scanner 77, the printer 78, the reader and writer 79, the change dispenser interface 80, the scale interface 81, and the like via the system transmission line 82.

The processor 71, the main memory 72, the auxiliary storage device 73, the clock 74, the communication interface 75, the touch panel 76, the scanner 77, the printer 78, the reader and writer 79, and the change dispenser interface 80 of the self-service POS terminal 61 have the functions equivalent to those of the processor 41, the main memory 42, the auxiliary storage device 43, the clock 44, the communication interface 45, the touch panel 46, the scanner 47, the printer 48, the reader and writer 49, and the change dispenser interface 410 of the settlement terminal 11 in the first embodiment. Therefore, the additional descriptions are omitted here.

The scale interface 81 is an interface for a weighing scale. The customer places the merchandise items, which were registered on the self-service POS terminal 61, one by one on the bagging table. The weighing scale is provided for the bagging table and measures the weight of the merchandise items placed on the bagging table. The unit weight of the merchandise item is preset in the merchandise record 311, and the processor 71 of the self-service POS terminal 61 compares the unit weight of the registered merchandise item with the weight of the merchandise item placed on the bagging table to determine the matching between the registered merchandise item and the bagged merchandise item. Then, if the matching is recognized, the processor 71 registers the data of the merchandise for which the registration operation was performed.

In some examples, an existing type self-service POS terminal can be used as the self-service POS terminal 61. However, in the present embodiment, the self-service POS terminal 61 uses part of the volatile memory area of the main memory 72 as a storage area for the transaction file 721. The data items stored in the transaction file 721 are the data items of the transaction file 521 described with reference to FIG. 10 except for the user ID and the delivery declaration flag Fc.

In addition, the self-service POS terminal 61 is mounted with a control program such that the processor 71 functions as a registration unit 711, a reception unit 712, an association unit 713, an output unit 714, a totalization unit 715, a delivery destination determination unit 716, and a packaging method determination unit 717. The control program is a kind of application program stored in the main memory 72 or the auxiliary storage device 73. The method of installing the control program in the main memory 72 or the auxiliary storage device 73 is not particularly limited. The control program can be recorded on a removable recording medium or distributed via communication via the communication network 65 and can be installed in the main memory 72 or the auxiliary storage device 73. The recording medium may be of any form, such as a CD-ROM, a memory card, and the like, as long as the recording medium can store the program and can be read by the device.

The registration unit 711 provides a function of registering merchandise to be purchased. The registration unit 711 registers the merchandise sales data related to the merchandise to be purchased in the transaction file 721 based on the data from the scanner 77 or the touch panel 76.

The reception unit 712 provides a function of receiving services to be applied to merchandise after checkout. The reception unit 712 receives a plurality of types of services via the touch panel 76. In the present embodiment, the reception unit 712 receives the delivery service and the packaging service.

The association unit 713 provides a function of storing the merchandise registered by the registration unit 711 and the service to be applied to the merchandise in association with each other. The association unit 713 stores the service data associated with the merchandise sales data registered in the transaction file 721, that is, the service status and the service code in the transaction file 721.

The output unit 714 provides a function of outputting the merchandise and services, which are associated by the association unit 713. The output unit 714 outputs the merchandise sales data and service data stored in the transaction file 721 to the printer 78.

The totalization unit 715 provides a function of summing the charge for the service received by the reception unit 712 with the price of the merchandise registered by the registration unit 711. At the self-service POS terminal 61, settlement processing is performed for the sum of the merchandise price and the service charge.

The delivery destination determination unit 716 provides a function of determining the delivery destination of the target merchandise if the delivery service is received by the reception unit 712. As the delivery destination, there are home and a place other than home, as in the first embodiment.

The packaging method determination unit 717 provides a function that determines the packaging method of the target merchandise if the packaging service is received by the reception unit 712. Packaging methods include simple packaging and gift wrapping as in the first embodiment.

Description of Operation of Self-service POS Terminal

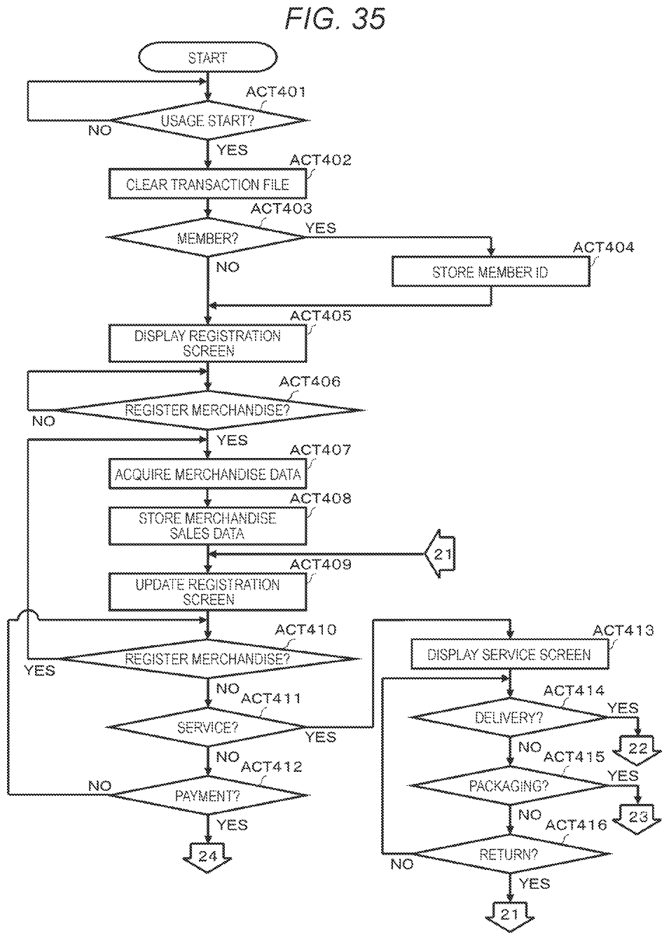

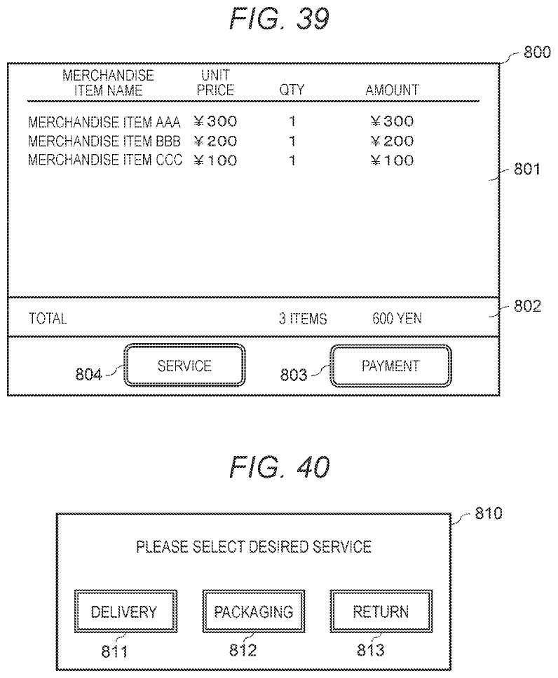

FIGS. 35 to 38 are flowcharts showing processing executed by the processor 71 of the self-service POS terminal 61 according to a control program. FIGS. 39 to 42 are schematic diagrams showing display examples of screens displayed on the touch panel 76 of the self-service POS terminal 61. FIG. 32 is a schematic diagram showing a print example of a receipt dispensed from the printer 78 of the self-service POS terminal 61. Certain operations of the self-service POS terminal 61 will be described below with reference to these drawings. In addition, the specific content of the operations described below is an example. As long as similar results can be obtained, the details of operation procedures and content are not particularly limited. Further, the layout of the screen display and receipt printing, text data, and the like are also examples and can be changed as appropriate.

The processor 71 waits for a usage start operation, as ACT 401. For example, an initial screen on which soft keys for a member key and a non-member key are arranged is displayed on the touch panel 76, and the processor 71 waits for input of the member key or the non-member key. A customer who is a member selects the member key to read the information on a membership card with the reader and writer 79 prior to registering the merchandise to be purchased. A customer who is not a member selects the non-member key.

If either the member key or non-member key is selected, the processor 71 recognizes that a usage start operation was performed. The processor 71 proceeds to ACT 402. The processor 71 clears the transaction file 402, as ACT 402. The processor 71 checks whether or not the usage start operation was the member key input operation, as ACT 403. In the case of a member key input operation, the processor 71 proceeds to ACT 404. The processor 71 acquires the member ID from the membership card information read by the reader and writer 79 and stores the member ID in the transaction file 721, as ACT 404. If the usage start operation is a non-member key input operation, the processor 71 skips the processing of ACT 404. If the processing of ACT 404 is completed or skipped, the processor 71 sets the screen of the touch panel 76 as a registration screen 800 (see FIG. 39), as ACT 405.

FIG. 39 is a schematic diagram showing a display example of the registration screen 800. The registration screen 800 includes a detail area 801 and a total area 802 of registered merchandise. In the detail area 801, detailed data such as the merchandise name, the sales quantity, and the sales amount of money of the merchandise registered by operating the scanner 77 or the touch panel 76 is displayed. The total area 802 displays the total quantity and total price of the registered merchandise. At the time of ACT 405, no information is displayed in the detail area 111 and the total area 112 because no merchandise was registered.

The registration screen 800 also has soft keys for a payment key 803 and a service key 804. The payment key 803 is pressed when a customer wants to make payment of the price. The service key 804 is pressed by the customer if a delivery service or packaging service is to be applied to the purchased merchandise. The service key 804 is an example of a collective instruction unit that requests the application of one or more services to one or more merchandise items registered by the registration unit 711.

The processor 71 that displayed the registration screen 800 waits for the registration operation of the merchandise purchased by the customer, as ACT 406. The merchandise registration operation is an operation of scanning the barcode of the merchandise with the scanner 77 or an operation of selecting merchandise having no barcode from the list of merchandise displayed on the touch panel 76. Through such a merchandise registration operation, the processor 71 can acquire the merchandise code of the registered merchandise.

The processor 71 that acquired the merchandise code of the registered merchandise accesses the store server 13 and acquires the merchandise data described in the merchandise record 311 including the merchandise code from the merchandise database 31, as ACT 407. Based on the merchandise data, the processor 71 stores merchandise sales data including the merchandise code, the merchandise name, the price, the sales quantity, the sales amount of money, the delivery target flag Fa, the packaging target flag Fb, and the like in the transaction file 721, as ACT 408. The processor 71 also updates the total data in the transaction file 721 at this time. The processor 71 updates the data in the detail area 801 and the total area 802 of the registration screen 800 based on the data in the transaction file 721, as ACT 409.

FIG. 39 exemplifies the registration screen 800 after the customer registered one merchandise item AAA with a unit price of 300 yen, one merchandise item BBB with a unit price of 200 yen, and one merchandise item CCC with a unit price of 100 yen. In the detail area 801, the merchandise name, the unit price, the sales quantity, and the sales amount of money are displayed as the detailed data of the registered merchandise for each line. The total area 802 displays the total quantity and the total price as total data.

The processor 71 that updated the registration screen 800 waits for the merchandise registration operation as ACT 410, the input of the service key 804 as ACT 411, or the input of the payment key 803 as ACT 412. In the standby state of ACT 410 to ACT 412, if the merchandise registration operation is performed, the processor 71 returns to ACT 407. The processor 71 executes the processing of ACT 407 to ACT 409 in the same manner as described above. Then, the processor 71 again enters a standby state for ACT 410 to ACT 412.

If the service key 804 is pressed in the standby state of ACT 410 to ACT 412, the processor 71 proceeds from ACT 411 to ACT 413. As ACT 413, the processor 71 sets the screen of the touch panel 76 as a service screen 810 (see FIG. 40).

FIG. 40 is a schematic diagram showing a display example of the service screen 810. The service screen 810 has a delivery key 811, a packaging key 812, and a return key 813 arranged. The delivery key 811 is selected when a customer requests a delivery service. The packaging key 812 is selected when a customer requests a packaging service. The return key 813 is selected when a customer stops the service request.

The processor 71 that displayed the service screen 810 waits for input of the delivery key 811 as ACT 414, the input of the packaging key 812 as ACT 415, or input of the return key 813 as ACT 416. If the return key 813 is pressed in the standby state of ACT 414 to ACT 416, the processor 71 returns from ACT 416 to ACT 409. The processor 71 clears the service screen 810 and returns the screen of the touch panel 76 to the registration screen 800.

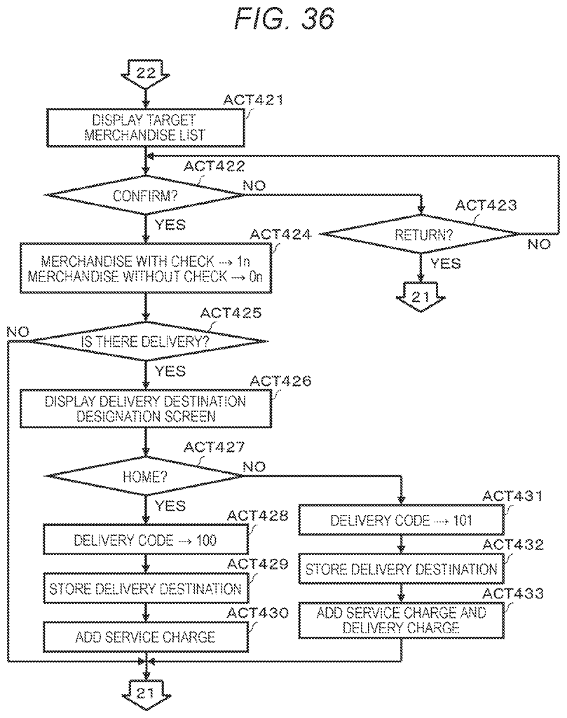

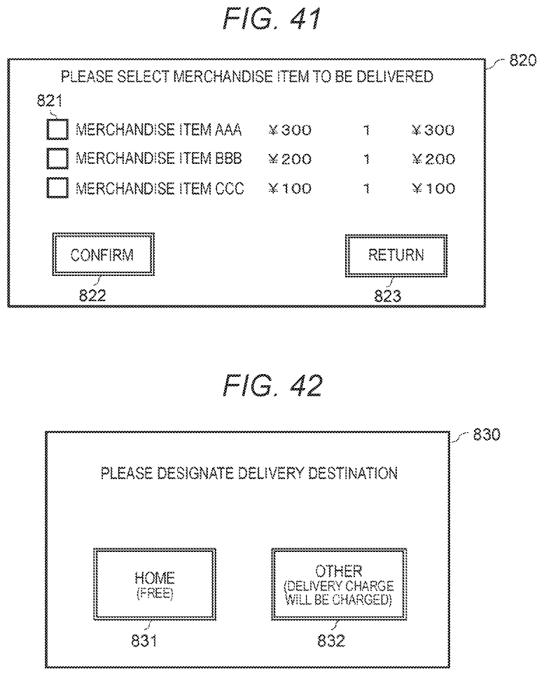

In the standby state of ACT 414 to ACT 416, if the delivery key 811 is pressed, the processor 71 proceeds from ACT 414 to ACT 421 in FIG. 36. As ACT 421, the processor 71 sets the screen of the touch panel 76 to a target merchandise list screen 820 of the delivery service (see FIG. 41).

FIG. 41 is a schematic diagram showing a display example of the target merchandise list screen 820. The target merchandise list screen 820 has a check box 821 arranged for each merchandise with respect to the list of the merchandise name, the unit price, the sales quantity, and the sales amount of money of the delivery service target merchandise for which the delivery target flag Fa is “1” among the items of merchandise whose merchandise sales data is registered in the transaction file 721. Also, the target merchandise list screen 820 has two soft keys: a confirmation key 822 and a return key 823. The customer selects the merchandise for which the delivery service is requested by checking the check box 821 of the merchandise. The check box 821 is an example of selection unit that selects a merchandise item to which a service is applied from among a plurality of merchandise items. The confirmation key 822 is pressed by the customer to confirm the merchandise items selected using the check box 821. The return key 823 is selected by the customer to stop the request for the delivery service.

The processor 71 that displayed the target merchandise list screen 820 waits for input of the confirmation key 822 as ACT 422 or input of the return key 823 as ACT 423. If the return key 823 is pressed in the standby state of ACT 422 and ACT 423, the processor 71 returns from ACT 423 to ACT 409 in FIG. 35. The processor 71 clears the target merchandise list screen 820 and returns the screen of the touch panel 76 to the registration screen 800.

In the standby state of ACT 422 and ACT 423, if the confirmation key 822 is pressed, the processor 71 proceeds from ACT 422 to ACT 424. The processor 71 sets the tens digit (place) of the service status of the service data stored in association with the merchandise sales data of the merchandise for which the check box 821 is checked to “1”, as ACT 424. The processor 71 also sets the tens digit of the service status of the service data stored in association with the merchandise sales data of the merchandise for which the check box 821 is not checked to “0”.

The processor 71 then checks whether or not there is a request for the delivery service, as ACT 425. According to the processing of ACT 424, if there is at least one item of merchandise whose tens digit in the service status is “1”, the processor 71 recognizes that there is a request for the delivery service. If there is no item of merchandise whose tens digit in the service status is “1”, the processor 71 recognizes that there is no request for the delivery service. If there is no request for the delivery service, the processor 71 returns to ACT 409 of FIG. 35. The processor 71 clears the target merchandise list screen 820 and returns the screen of the touch panel 76 to the registration screen 800.

In ACT 425, if there is a request for the delivery service, the processor 71 proceeds to ACT 426. As ACT 426, the processor 71 sets the screen of the touch panel 76 as a delivery destination designation screen 830 (see FIG. 42).

FIG. 42 is a schematic diagram showing a display example of the delivery destination designation screen 830. The delivery destination designation screen 830 has two soft keys: a home key 831 and an other key 832. A customer whose delivery destination is home (home address) selects the home key 831. A customer whose delivery destination is other than the home address selects the other key 832.

The processor 71 that displayed the delivery destination designation screen 830 waits for the delivery destination to be designated, as ACT 427. If the home key 831 is pressed, the processor 71 recognizes that the home is designated as the delivery destination. If the other key 832 is pressed, the processor 71 recognizes that a place other than home is designated as the delivery destination. Here, if a delivery address is registered in the member record 321 identified by the member ID of the customer who selects the other key 832, a list of delivery addresses, a so-called delivery destination list, can be displayed on the delivery destination designation screen 830. Then, the customer selects the desired delivery address from the delivery destination list. Once an address is selected, the processor 71 recognizes that address has been designated as the delivery destination. If there is no desired delivery destination in the delivery destination list, the customer selects NOT AVAILABLE. In the case of NOT AVAILABLE, the processor 71 recognizes that a place other than home is designated as the delivery destination.

If the home is designated as the delivery destination, the processor 71 proceeds to ACT 428. In ACT 428, the processor 71 sets the delivery code of the service data with the tens digit of “1” in the service status to “100”. The processor 71 also stores information indicating the delivery destination, that is, information indicating that the home is designated as the delivery destination in the transaction file 721, as ACT 429. Further, the processor 71 adds the service charge set in the service record 3311 of the delivery code “100” to the service charge and the price of the total data of the transaction file 521, respectively, as ACT 430.

In ACT 427, if a delivery destination other than home is designated, the processor 71 proceeds to ACT 431. In ACT 431, the processor 71 sets the delivery code of the service data with the tens digit of “1” in the service status to “101”. The processor 71 also stores information indicating the delivery destination, that is, information indicating that the delivery destination is other than home or that the delivery address is designated in the transaction file 721, as ACT 432. Further, the processor 71 adds the service charge set in the service record 3311 of the delivery code “100” and the delivery charge set in the service record 3312 of the delivery code “101” to the service charge and the price of the total data of the transaction file 521, respectively, as ACT 433.

After the processing of ACT 430 or ACT 433 is completed, the processor 71 returns to ACT 409 of FIG. 35. The processor 71 clears the delivery destination designation screen 830 and returns the screen of the touch panel 76 to the registration screen 800.

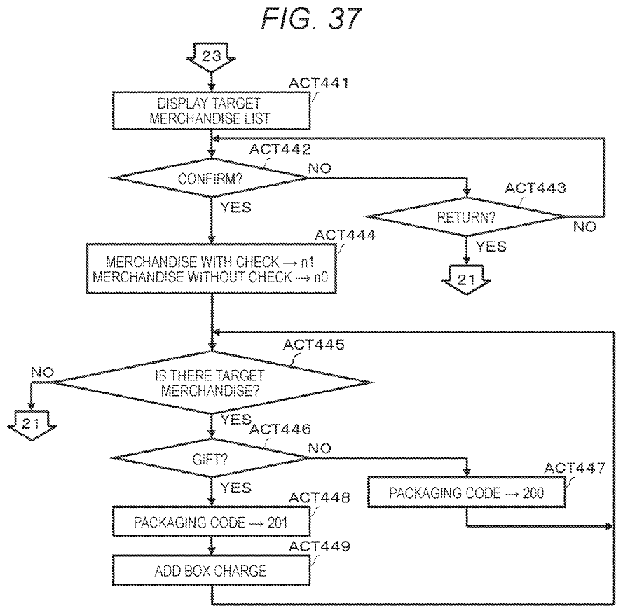

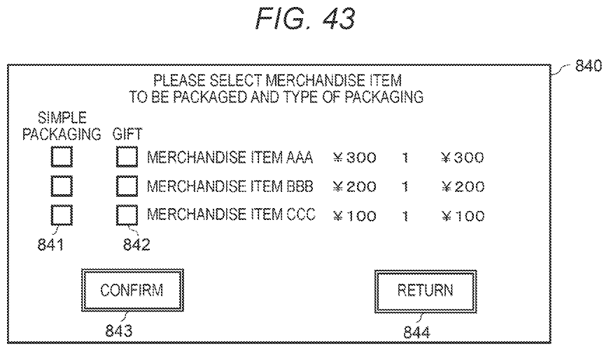

In the standby state of ACT 414 to ACT 416, if the packaging key 812 is pressed, the processor 71 proceeds from ACT 415 to ACT 441 in FIG. 37. As ACT 441, the processor 71 sets the screen of the touch panel 76 as a target merchandise list screen 840 (see FIG. 43) of the packaging service.

FIG. 43 is a schematic diagram showing a display example of the target merchandise list screen 840. The target merchandise list screen 840 has a first check box 841 and a second check box 842 arranged for each merchandise with respect to the list of the merchandise name, the unit price, the sales quantity, and the sales amount of money of the packaging service target merchandise for which the packaging target flag Fb is “1” among the merchandise for which merchandise sales data is registered in the transaction file 721. Also, the target merchandise list screen 840 has two soft keys: a confirmation key 843 and a return key 844. If the customer requests the simple packaging service in the packaging service, the customer checks the first check box 841 of the corresponding merchandise to make a selection. If the customer requests the gift wrapping service in the packaging service, the customer checks the second check box 842 of the corresponding merchandise to make a selection. Both the first check box 841 and the second check box 842 cannot be checked. The first check box 841 and the second check box 842 are examples of selection unit that are used to select merchandise to which a service is to be applied from among a plurality of merchandise. The confirmation key 843 is selected by the customer to confirm the merchandise selected using the first check box 841 or the second check box 842. The return key 844 is pressed by the customer to stop the packaging service request.

The processor 71 that displayed the target merchandise list screen 840 waits for input of the confirmation key 843 as ACT 442 or input of the return key 844 as ACT 443. If the return key 844 is pressed in the standby state of ACT 442 and ACT 443, the processor 71 returns from ACT 443 to ACT 409 of FIG. 35. The processor 71 clears the target merchandise list screen 840 and returns the screen of the touch panel 76 to the registration screen 800.

In the standby state of ACT 442 and ACT 443, if the confirmation key 843 is pressed, the processor 71 proceeds from ACT 442 to ACT 444. As ACT 444, the processor 71 sets the ones digit of the service status of the service data stored in association with the merchandise sales data of the merchandise for which the first check box 841 or the second check box 842 is checked to “1”. Also, the processor 71 sets the ones digit of the service status of the service data stored in association with the merchandise sales data of the merchandise for which the first check box 841 or the second check box 842 is unchecked to “0”.

The processor 71 checks whether or not there is a request for the packaging service, as ACT 445. If there is at least one item of merchandise whose ones digit in the service status is set as “1” by the processing of ACT 444, the processor 71 recognizes that there is a request for the packaging service. If there is no item of merchandise whose ones digit in the service status is “1”, the processor 71 recognizes that there is no request for the packaging service. If there is no request for the packaging service, the processor 71 returns to ACT 409 of FIG. 35. The processor 71 clears the target merchandise list screen 840 and returns the screen of the touch panel 76 to the registration screen 800.

In ACT 445, if there is a request for the packaging service, the processor 71 proceeds to ACT 446. The processor 71 identifies the packaging method, as ACT 446. The processor 71 recognizes that the packaging method for the merchandise for which the first check box 841 is checked is simple packaging. The processor 71 recognizes that the packaging method for the merchandise for which the second check box 842 is checked is gift wrapping.

If the packaging method is simple packaging, the processor 71 proceeds to ACT 447. In ACT 447, the processor 71 sets the packaging code of the service data with the ones digit of “1” in the service status to “200”.

In ACT 446, if the packaging method is gift wrapping, the processor 71 proceeds to ACT 448. As ACT 448, the processor 71 sets the packaging code of the service data with the ones digit of “1” in the service status to “201”. The processor 71 also adds the box charge set in the service record 3314 of the packaging code “201” to the service charge and price of the total data of the transaction file 521, respectively, as ACT 449.

After the processing of ACT 447 or ACT 449 is completed, the processor 71 returns to ACT 409 of FIG. 35. The processor 71 clears the delivery destination designation screen 830 and returns the screen of the touch panel 76 to the registration screen 800.

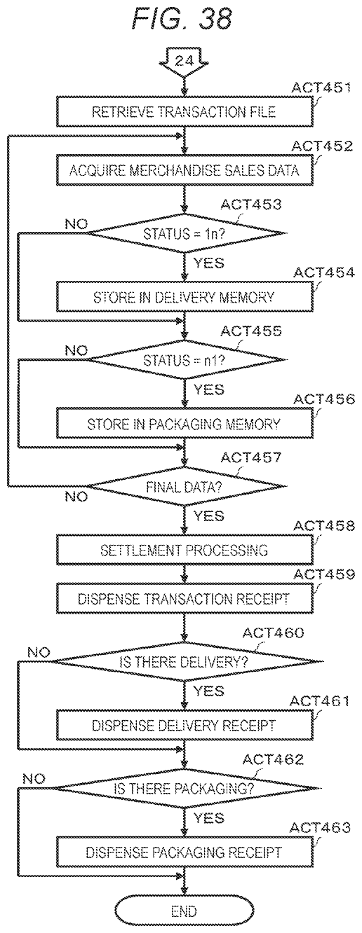

If the payment key 803 is pressed in the standby state of ACT 410 to ACT 412, the processor 71 proceeds from ACT 412 to ACT 451 of FIG. 38. The processor 71 retrieves the transaction file 721 as ACT 451. The processor 71 acquires the top merchandise sales data from the transaction file 721 as ACT 452. The processor 71 then checks the service status of the service data associated with the merchandise sales data as ACT 543. If the tens digit in the service status is “1”, that is, if the delivery service is designated for the merchandise in the merchandise sales data associated with the service data, the processor 71 proceeds to ACT 454. The processor 71 stores the merchandise sales data in the delivery memory, as ACT 454. The delivery memory is part of the volatile memory area of the main memory 72. If the tens digit in the service status is “0”, the processor 71 skips the processing of ACT 454.

If the processing of ACT 454 is completed or skipped, the processor 71 checks whether or not the ones digit of the service data is “1”, as ACT 455. If the ones digit of the service data is “1”, that is, if the packaging service is designated for the merchandise in the merchandise sales data associated with the service data, the processor 71 proceeds to ACT 456. The processor 71 stores the merchandise sales data in the packaging memory, as ACT 456. The packaging memory is part of the volatile memory area of the main memory 72. If the ones digit in the service status is “0”, the processor 71 skips the processing of ACT 456.

If the processing of ACT 456 is completed or skipped, the processor 71 checks whether or not the processing of ACT 452 to ACT 456 described above was executed for all the merchandise sales data stored in the transaction file 721, as ACT 457. If there is merchandise sales data for which the processing of ACT 452 to ACT 456 was not executed, the processor 71 returns to ACT 452. The processor 71 then acquires the next merchandise sales data from the transaction file 721 and executes the processing of ACT 453 to ACT 456.

When executing the processing of ACT 452 to ACT 456 is finished for all the merchandise sales data stored in the transaction file 721, the processor 71 proceeds to ACT 458. The processor 71 executes the settlement processing for the total price stored in the transaction file 721, as ACT 458. The settlement processing may be any one of cash settlement processing, credit settlement processing, electronic money settlement processing, and code settlement processing. Also, other settlement processing may be used.

After completing the settlement processing, the processor 71 controls the dispensing of the transaction receipt 201 (see FIG. 32), as ACT 459. That is, the processor 71 generates print data for the transaction receipt 201 based on the stored transaction data stored in the transaction file and outputs this print data to the printer 78.

Next, the processor 71 checks whether or not the merchandise sales data is stored in the delivery memory, as ACT 460. If the delivery memory stores merchandise sales data, the processor 71 proceeds to ACT 461. The processor 71 controls the dispensing of the delivery receipt 202 (see FIG. 32), as ACT 461. That is, the processor 71 generates print data for the delivery receipt 202 based on the merchandise sales data stored in the delivery memory, and outputs this print data to the printer 78. If no merchandise sales data is stored in the delivery memory, the processor 71 skips the processing of ACT 461.

If the processing of ACT 461 is completed or skipped, the processor 71 checks whether or not merchandise sales data is stored in the packaging memory, as ACT 462. If the packaging memory stores merchandise sales data, the processor 71 proceeds to ACT 463. The processor 71 controls the dispensing of the packaging receipt 203 (see FIG. 32), as ACT 463. That is, the processor 71 generates print data for the packaging receipt 203 based on the merchandise sales data stored in the packaging memory, and outputs this print data to the printer 78. If no merchandise sales data is stored in the packaging memory, the processor 71 skips the processing of ACT 463.

If the processing of ACT 463 is completed or skipped, the processor 71 ends the information processing of the procedures shown in the flowcharts of FIGS. 35 to 38.

<Description of Function of Self-Service POS Terminal>

The processor 71 of the self-service POS terminal 61 that operates in this way implements the function as the registration unit 711 by executing the processing of ACT 406 to ACT 410 in FIG. 35.

The processor 71 implements the function as the reception unit 712 by executing the processing of ACT 421 to ACT 424 in FIG. 36. Also, the processor 71 implements the function as the reception unit 712 by executing the processing of ACT 441 to ACT 444 in FIG. 37.

The processor 71 implements the function as the association unit 513 by executing the processing of ACT 428 and ACT 431 of FIG. 36. Also, the processor 71 implements the function as the association unit 713 by executing the processing of ACT 447 and ACT 448 of FIG. 37.

The processor 71 implements the function as the output unit 714 by executing the processing of ACT 460 to ACT 463 in FIG. 38.

The processor 71 implements the function as the totalization unit 715 by executing the processing of ACT 430, ACT 433 of FIG. 36, and ACT 449 of FIG. 37.

The processor 71 implements the function as the delivery destination determination unit 716 by executing the processing of ACT 429 and ACT 432 of FIG. 36.

The processor 71 implements the function as the packaging method determination unit 517 by executing the processing of ACT 446 in FIG. 37.

Effects of Merchandise Registration System

If the customer uses the self-service POS terminal 61 to register the merchandise to be purchased, the registration screen 800 is displayed on the touch panel 76 of the self-service POS terminal 61. Therefore, the customer who desires to use the delivery service selects the service key 804. Then, the screen of the touch panel 76 transitions from the registration screen 800 to the service screen 810, and the customer presses the delivery key 811. Then, the screen of the touch panel 76 transitions from the service screen 810 to the target merchandise list screen 820, and thus, the customer puts a check in the check box 821 corresponding to the merchandise for which the delivery service is requested and enters the confirmation key 822. Then, the screen of the touch panel 76 transitions from the target merchandise list screen 820 to the delivery destination designation screen 830, and the customer designates the desired delivery destination. Then, the screen of the touch panel 76 returns from the delivery destination designation screen 830 to the registration screen 800, and the customer inputs the payment key 803.

By performing the above operations, the delivery receipt 202 is dispensed together with the transaction receipt 201 from the self-service POS terminal 61, similar to the settlement terminal 11 of the first embodiment. Therefore, in the merchandise registration system 6 of the second embodiment, as in the first embodiment, it is possible to improve the efficiency of the delivery service reception work at the service counter. In addition, if the store clerk implements the operation of arranging the merchandise to be delivered according to the delivery receipt 202, the number of users of the delivery service can be increased, and an increase in store sales can be expected.

A customer who has registered merchandise for which he/she wishes to request the packaging service selects the service key 804 on the registration screen 800 and then the packaging key 812 on the service screen 810. Then, the screen of the touch panel 76 transitions from the service screen 810 to the target merchandise list screen 840, and thus, the customer checks the first check box 841 or the second check box 842 corresponding to the merchandise for which the packaging service is requested. Then, the screen of the touch panel 76 returns from the target merchandise list screen 840 to the registration screen 800, and the customer selects the payment key 803.

By performing the above operations, the self-service POS terminal 61 dispenses the transaction receipt 201 and the packaging receipt 203 as with the settlement terminal 11 of the first embodiment. Therefore, in the merchandise registration system 6 of the second embodiment, as in the first embodiment, it is possible to improve the efficiency of the packaging service reception work at the service counter.

Modification

In an embodiment, the delivery service and the packaging service were examples of services that can be provided at the service counter. The type of service is not limited thereto. For example, for a warranty period extension service, special dishes (e.g., non-standard preparations), a reservation service for seasonal merchandise such as Christmas cakes, or the like can be provided in a similar manner as the delivery service or the packaging service of the examples, and the efficiency of operations at the service counter providing such other services can be improved.

In an embodiment, the case where the delivery receipt 202 or the packaging receipt 203 is dispensed from the settlement terminal 11 or the self-service POS terminal 61 is exemplified. In other examples, a network printer can be installed at a service counter and connected to the communication network 16 or the communication network 65. Then, the settlement terminal 11 or the self-service POS terminal 61 outputs the print data of the delivery receipt 202 or the packaging receipt 203 to the network printer for printing. By doing so, the customer effort required for obtaining and presenting the delivery receipt 202 or the packaging receipt 203 dispensed from the settlement terminal 11 or the self-service POS terminal 61 to the store clerk at the service counter can be eliminated. In a particular example, for a store where a store clerk prepares the merchandise to be delivered according to the delivery receipt 202, the customer who requests the delivery service does not actually have to go to the service counter to request the delivery (or other similar service). In some examples, a display device (e.g., order status screen) may be provided in place of the receipt printer so that the store clerk can check the contents of the delivery receipt 202 or the packaging receipt 203 as presented on the screen display.

Also, regarding the delivery receipt 202, the information of the merchandise for which the delivery service is requested and the information indicating the delivery destination can be printed on the delivery receipt 202 in a barcode or two-dimensional code system. Similarly, regarding the packaging receipt 203, the merchandise name and quantity of the merchandise for which the packaging service is requested, and the information about the packaging method can be printed on the packaging receipt 203 in a barcode or two-dimensional code system. When doing so, the store clerk at the service counter reads the barcode or two-dimensional code printed on the delivery receipt 202 or the packaging receipt 203 with a code reader of a terminal, whereby information for the delivery or packaging work can be provided. Therefore, the service request reception work can be made more efficient.

In the service screen 120 according to the first embodiment, if the delivery target flag Fa of the service-requested merchandise is “0”, that is, in the case of the merchandise that is not available for the delivery service, the delivery key may be grayed out to prevent the input operation. Similarly, if the packaging target flag Fb of the service-requested merchandise is “0”, that is, in the case of the merchandise that is not available for the packaging service, the packaging key may be grayed out to prevent the input operation. By doing this, no negative response is returned from the mobile controller 14, and thus, the mobile controller 14 can omit the information processing regarding the negative response. As a result, the processing efficiency of the mobile controller 14 can be improved.

In the first embodiment, the case where the service key 114 is displayed for each detailed data displayed in the detail area 111 of the registration screen 110 was exemplified. As another embodiment, instead of the service key 114, a delivery key and a packaging key on the service screen 120 are displayed respectively. If the delivery key is selected, the processor 21 may execute ACT 26 to ACT 28 of FIG. 14, and if the packaging key is selected, the processor 21 may execute ACT 29 to ACT 32 of FIG. 14. In such an embodiment, the delivery key and packaging key serve as the individual instruction unit.

The order in which the transaction receipt 201, the delivery receipt 202, and the packaging receipt 203 are dispensed is not limited. For example, the delivery receipt 202 or the packaging receipt 203 may be dispensed first, and the transaction receipt 201 may be dispensed later. By doing so, it is possible to prevent the customer forgetting to take the delivery receipt 202 or the packaging receipt 203.

A collective selection key may be added to the target merchandise list screen 820 in the second embodiment, and if this collective selection key is selected, all check boxes 821 corresponding to each merchandise may be checked. By doing so, it is possible to improve the operability of the customer when requesting the delivery service for all items.

In the second embodiment, the processor of the POS terminal 62 is configured to have the functions of the registration unit 711, the reception unit 712, the association unit 713, the output unit 714, the totalization unit 715, the delivery destination determination unit 716, and the packaging method determination unit 717. The store clerk may then operate the POS terminal 62 to dispense the delivery receipt 202 or the packaging receipt 203 in response to a request from the customer. As described above, the delivery service is frequently used by the elderly, and many of the elderly dislike using self-service POS terminals 61. Therefore, there is a potential advantage in using the POS terminal 62 as a merchandise registration device.

In an embodiment the mobile controller 14 is connected to the communication network 16. In another embodiment, one or more function of the mobile controller 14 may be implemented by a cloud server on the Internet. In this case, the cloud server on the Internet is connected to the wide area network and implements the function of the mobile controller 14. By implementing the function of the mobile controller 14 with the cloud server, the provision of such function can be easily expanded.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A merchandise registration device, comprising:
a processor configured to:
register merchandise to be purchased by a customer in a sales transaction;
receive a designation of services to be applied to the registered merchandise after settlement of the sales transaction;
store the designation of services in association with the registered merchandise; and
output a list of the registered merchandise associated with the designated services to be applied after settlement of the sale transaction.

2. The merchandise registration device according to claim 1, wherein the processor is further configured to:
add a charge for the designated services to a summed total of the prices of the registered merchandise of the sales transaction.

3. The merchandise registration device according to claim 1, further comprising:
a display screen, wherein
the processor is further configured to:
display a list registered merchandise on the display screen in conjunction with a service request operator for each item of registered merchandise on the list by which the customer can designate a service to be applied to each item individually.

4. The merchandise registration device according to claim 3, wherein the processor is further configured to:
display the list registered merchandise on the display screen in conjunction with a collective service request operator by which the customer can designate a service to be applied to every item of registered merchandise collectively.

5. The merchandise registration device according to claim 1, further comprising:
a code reader configured to read encoded transaction data from an information terminal operated by the customer.

6. The merchandise registration device according to claim 5, wherein the encoded transaction data includes a transaction ID associated with items of merchandise to be purchased by the customer in the sales transaction.

7. The merchandise registration device according to claim 5, wherein the encoded transaction data includes the designation of services.

8. The merchandise registration device according to claim 1, further comprising:
a printer configured to print a transaction receipt corresponding to the list of the registered merchandise output by the processor.

9. The merchandise registration device according to claim 8, wherein the printer is further configured to print a service designation receipt listing registered merchandise for which a service designation was received.

10. The merchandise registration device according to claim 1, further comprising:
a communication interface configured to connect to an attendant terminal at a service counter, wherein
the list of the registered merchandise associated with the designated services to be applied after settlement of the sale transaction is output to the attendant terminal via the communication interface.

11. A merchandise registration system, comprising:
a merchandise registration device for registering items of merchandise in a sales transaction; and
a settlement terminal for receiving payment for settlement of the sales transaction, wherein
the merchandise registration device includes:
a processor configured to:
register merchandise to be purchased by a customer in the sales transaction;
receive a designation of services to be applied to the registered merchandise after settlement of the sales transaction;
store the designation of services in association with the registered merchandise; and
output a list of the registered merchandise associated with the designated services to be applied after settlement of the sale transaction.

12. The merchandise registration system according to claim 11, wherein
the processor is further configured to:
add a charge for the designated services to a summed total of the prices of the registered merchandise of the sales transaction, and
the payment for settlement of the sales transaction includes the charge for the designated services.

13. The merchandise registration system according to claim 12, wherein
the merchandise registration device further includes a display screen, and
the processor is further configured to:
display a list registered merchandise on the display screen in conjunction with a service request operator for each item of registered merchandise on the list by which the customer can designate a service to be applied to each item individually.

14. The merchandise registration system according to claim 13, wherein the processor is further configured to:
display the list registered merchandise on the display screen in conjunction with a collective service request operator by which the customer can designate a service to be applied to every item of registered merchandise collectively.

15. The merchandise registration system according to claim 11, wherein the merchandise registration device further includes:
a code reader configured to read encoded transaction data from an information terminal operated by the customer.

16. The merchandise registration system according to claim 11, wherein the merchandise registration device is a semi-self service point of sale terminal.

17. The merchandise registration system according to claim 11, wherein the merchandise registration device is a mobile information device operated by the customer.

18. The merchandise registration system according to claim 11, wherein the settlement terminal includes:
a printer configured to print a transaction receipt corresponding to the list of the registered merchandise output by the processor.

19. The merchandise registration system according to claim 18, wherein the printer is further configured to print a service designation receipt listing registered merchandise for which a service designation was received.

20. A non-transitory computer-readable medium storing program instructions which when executed by a processor of a merchandise registration device causes the merchandise registration device to perform a method comprising:
register merchandise to be purchased by a customer in the sales transaction;
receive a designation of services to be applied to the registered merchandise after settlement of the sales transaction;
store the designation of services in association with the registered merchandise; and
output a list of the registered merchandise associated with the designated services to be applied after settlement of the sale transaction.
